(19) United States
(12) Patent Application Publication
(10) Pub. No.: US 2016/0267720 A1
(43) Pub. Date: Sep. 15, 2016

(54) Pleasant and Realistic Virtual/Augmented/Mixed Reality Experience

(71) Applicant: Electronic Scripting Products, Inc., Palo Alto, CA (US)

(72) Inventors: Michael J. Mandella, Palo Alto, CA (US); Hector H. Gonzalez-Banos, Mountain View, CA (US); Marek Alboszta, Montara, CA (US)

(21) Appl. No.: 15/165,955

(22) Filed: May 26, 2016

Related U.S. Application Data
(63) Continuation-in-part of application No. 14/965,544, filed on Dec. 10, 2015.
Application No. 14/965,544 is a continuation-in-part of application No. 13/199,239, filed on Aug. 22, 2011, now Pat. No. 9,229,540.
Application No. 13/199,239 is a continuation-in-part of application No. 10/769,484, filed on Jan. 30, 2004, now Pat. No. 8,542,219.
Application No. 14/965,544 is a continuation-in-part of application No. 14/551,367, filed on Nov. 24, 2014, now Pat. No. 9,235,934.
Application No. 14/551,367 is a continuation of application No. 13/889,748, filed on May 8, 2013, now Pat. No. 8,897,494.
Application No. 13/889,748 is a division of application No. 13/134,006, filed on May 25, 2011, now Pat. No. 8,553,935.
Application No. 13/134,006 is a division of application No. 12/586,226, filed on Sep. 18, 2009, now Pat. No. 7,961,909.
Application No. 12/586,226 is a continuation-in-part of application No. 12/584,402, filed on Sep. 3, 2009, now Pat. No. 7,826,641.
Application No. 12/584,402 is a continuation-in-part of application No. 11/591,403, filed on Oct. 31, 2006, now Pat. No. 7,729,515.
(60) Provisional application No. 60/780,937, filed on Mar. 8, 2006.

(51) Int. Cl. G06T 19/00; G02B 27/01; H04N 13/04; G06F 1/16; H04N 5/232; G06T 1/20

(52) U.S. Cl. CPC G06T 19/006; H04N 5/232; G06T 1/20; H04N 13/044; G06F 1/163; G02B 27/0172; G02B 2027/014; G02B 2027/0134

(57) ABSTRACT

The present invention discloses apparatus and methods for the viewing of a reality, and in particular a comfortable and pleasant viewing of the reality by a user. The reality is viewed by the user with a viewing mechanism that may involve optics. The reality viewed may be a virtual reality, an augmented reality or a mixed reality. A projection mechanism renders the scene for the user and modifies one or more virtual objects present in the scene. The modification performed is based on one or more properties of an inside-out camera. The modification and the associated property/properties of the inside-out camera are suitably chosen to fit an application need such as to provide a pleasant and comfortable viewing experience for the user. The inside-out camera may be attached to the viewing mechanism, which may be worn by the user. The reality viewed may be from the viewpoint of the user, or from the viewpoint of another device detached from the user.

### RELATED APPLICATIONS

This application is a Continuation-in-part of U.S. patent application Ser. No. 14/965,544 filed on Dec. 10, which is a Continuation-in-part of U.S. patent application Ser. No. 13/199,239 filed on Aug. 22, 2011 now U.S. Pat. No. 9,229,540, which is a Continuation-in-part of U.S. patent application Ser. No. 10/769,484 filed on Jan. 30, 2004 now U.S. Pat. No. 8,542,219.

The above referenced U.S. patent application Ser. No. 14/965,544 filed on Dec. 10, 2015 is also a Continuation-in-part of U.S. patent application Ser. No. 14/551,367 filed on Nov. 24, 2014 now U.S. patent Ser. No. 9,235,934, which is a Continuation of U.S. patent application Ser. No. 13/889,748 filed on May 8, 2013 now U.S. Pat. No. 8,897,494, which is a Division of U.S. patent application Ser. No. 13/134,006 filed on May 25, 2011 now U.S. Pat. No. 8,553,935, which is a Division of U.S. patent application Ser. No. 12/586,226 filed on Sep. 18, 2009 now U.S. Pat. No. 7,961,909, which is a Continuation-in-part of U.S. patent application Ser. No. 12/584,402 filed on Sep. 3, 2009 now U.S. Pat. No. 7,826,641, which is a Continuation-in-part of U.S. patent application Ser. No. 11/591,403 filed on Oct. 31, 2006 now U.S. Pat. No. 7,729,515 which claims priority from U.S. Provisional Patent Application No. 60/780,937 filed on Mar. 8, 2006.

All the above numbered applications are incorporated by reference herein in their entireties.

### FIELD OF THE INVENTION

The present invention relates generally to the viewing of a reality, and in particular to a comfortable, pleasant, informative and realistic viewing of such a reality by a user. The reality can be a virtual reality, an augmented reality or a mixed reality.

### BACKGROUND OF THE INVENTION

When an item moves without constraints in a three-dimensional environment with respect to stationary objects, knowledge of the item's distance from and inclination to these objects can be used to derive a variety of the item's parameters of motion as well as its pose. Particularly useful stationary objects for pose recovery purposes include a ground plane, fixed points, lines, reference surfaces and other known features.

Over time, many useful coordinate systems and methods have been developed to parameterize stable reference frames defined by stationary objects. The pose of the item, as recovered and expressed in such stable frames with parameters obtained from the corresponding coordinate description of the frame, is frequently referred to as the item's absolute pose. Based on the most up-to-date science, we know that no absolute or stationary frame is available for defining truly absolute parameters. Stable frame is thus not to be construed to imply a stationary frame. More precisely stated, the stable frame in which the absolute pose is parameterized is typically not a stationary or even an inertial frame (for example, a reference frame defined on the Earth's surface is certainly stable, but not stationary and non-inertial due to gravity and Earth's rotation). Nevertheless, we shall refer to poses defined in stable frames as “absolute” in adherence to convention.

Many conventions have also been devised to track temporal changes in absolute pose of the items as it undergoes motion in the three-dimensional environment. Certain types of motion in three dimensions can be fully described by corresponding equations of motion (e.g., orbital motion, simple harmonic motion, parabolic motion, curvilinear motion, etc.). These equations of motion are typically expressed in the stable frame defined by the stationary objects.

The parameterization of stable frames is usually dictated by the symmetry of the situation and overall type of motion. For example, motion exhibiting spherical symmetry is usually described in spherical coordinates, motion exhibiting cylindrical symmetry in cylindrical coordinates and generally linear motion in Cartesian coordinates. More advanced situations may even be expressed in coordinates using other types of parameterizations, e.g., sets of linearly independent axes.

Unconstrained motion of items in many three-dimensional environments, however, may not lend itself to a simple description in terms of equations of motion. Instead, the best approach is to recover a time sequence of the item's absolute poses and reconstruct the motion from them. For a theoretical background, the reader is referred to textbooks on classical mechanics and, more specifically, to chapters addressing various types of rigid body motion. An excellent overall review is found in H. Goldstein et al., Classical Mechanics, 3^{rd} Edition, Addison Wesley Publishing, 2002.

Items associated with human users, e.g., items that are manipulated or worn by such users, generally do not move in ways that can be described by simple equations of motion. That is because human users exercise their own will in moving such items in whatever real three-dimensional environment they find themselves. It is, however, precisely the three-dimensional motion of such items that is very useful to capture and describe. That is because such motion may communicate the desires and intentions of the human user. These desires and intentions, as expressed by corresponding movements of the item (e.g., gestures performed with the item), can form the basis for user input and interactions with the digital domain (e.g., data input or control input).

In one specific field, it is important to know the absolute pose of an item associated with a human user to derive the position of its tip while it contacts a plane surface. Such position represents a subset of the absolute pose information. Various types of items, such as elongate objects, can benefit from knowledge of their pose, which includes the position of their tip. More precisely, such items would benefit from knowing the absolute position (in world coordinates parameterizing the stable frame) of their tip while it is in contact with a plane surface embedded in the three-dimensional environment. These items include walking canes when in touch with the ground, pointers when in touch with a display or projection surface, writing devices when in touch with a writing surface, and styluses when in touch with an input screen.

The need to determine the absolute position of the tip or nib is deeply felt in the field of input devices such as pens and styluses. Here, the absolute position of the tip has to be known in order to analyze the information written or traced by the user on the writing surface. Numerous teachings of pens and related input devices providing relative tip position and absolute tip position are discussed in the prior art. Some of these teachings rely on inertial navigation devices including gyroscopes and accelerometers as described in U.S. Pat. Nos. 6,492,981; 6,212,296; 6,181,329; 5,981,884; 5,902,968. Others combine inertial navigation with force sensing as described in U.S. Pat. Nos. 6,081,261; 5,434,371. Still other techniques rely on triangulation using signal receivers and auxiliary devices on or adjacent to the writing surface as found in U.S. Pat. Nos. 6,177,927; 6,124,847; 6,104,387; 6,100,877; 5,977,958 and 5,484,966. Furthermore, various forms of radiation including short radio-frequency (RF) pulses, infra-red (IR) pulses, and even sound waves in the form of ultrasound pulses have been taught for triangulation and related techniques. A few examples of yet another set of solutions employing digitizers or tablets are discussed in U.S. Pat. Nos. 6,050,490; 5,750,939; 4,471,162.

The prior art also addresses the use of optical systems to provide relative, and in some cases, absolute position of the tip of a pen or stylus on a surface. For example, U.S. Pat. No. 6,153,836 teaches emitting two light beams from the stylus to two receivers that determine angles with respect to a two-dimensional coordinate system defined within the surface. The tip position of the stylus is found with the aid of these angles and knowledge of the location of the receivers. U.S. Pat. No. 6,044,165 teaches integration of force sensing at the tip of the pen with an optical imaging system having a camera positioned in the world coordinates and looking at the pen and paper. Still other teachings use optical systems observing the tip of the pen and its vicinity. These teachings include, among others, U.S. Pat. Nos. 6,031,936; 5,960,124; 5,850,058. According to another approach, the disclosure in U.S. Pat. No. 5,103,486 proposes using an optical ballpoint in the pen. More recently, optical systems using a light source directing light at paper have been taught, e.g., as described in U.S. Pat. Nos. 6,650,320; 6,592,039 as well as WO 00217222 and U.S. Patent Appl. Nos. 2003-0106985; 2002-0048404.

In some prior art approaches the writing surface is provided with special markings that the optical system can recognize. Some early examples of pens using special markings on the writing surface include U.S. Pat. Nos. 5,661,506; 5,652,412. More recently, such approach has been taught in U.S. Patent Appl. 2003-0107558 and related literature. For still further references, the reader is referred to U.S. patent application Ser. Nos. 10/640,942 and 10/745,371 and the references cited therein.

The rich stream of information expressing an item's absolute pose combines its three linear or translational degrees of freedom with its three rotational degrees of freedom. Typically, translations are measured along linearly independent axes such as the X, Y, and Z-axes. The translation or displacement along these axes is usually measured by the position (x,y,z) of a reference point on the item (e.g., the center of mass of the item). The three-dimensional orientation of the item is typically expressed by rotations taken around three linearly independent axes. The latter are typically expressed with three rotation angles, such as the Euler angles (φ,θ,ψ).

However the prior art comes short on several fronts when it comes to providing a rich, and comfortable virtual reality, augmented reality or mixed reality experience to the user. In particular, the prior art does not teach a system or methods for utilizing a viewing mechanism to view a reality/environment comprising real and/or virtual objects, where the virtual objects may be altered or modified based on one or more properties of an inside-out camera. Examples of such one or more properties include the pose of the camera or a reduced homography. The reality viewed by the user may be a virtual reality, an augmented reality or a mixed reality. The above alteration or modification of the virtual objects may be necessary to avoid motion sickness for the user. Such a sickness occurs because of the conflict between the vestibular and ocular responses of the brain, as a result of the motion of the user and the system's inability to render appropriate and timely changes to the images/reality viewed by the user.

The prior art is also silent about the many different choices available for the properties of the inside-out camera according to which the virtual object(s) in the reality may be modified as described above. Such modification(s) may be necessary to enhance the experience of the user in viewing the reality. The prior art is also silent about the fact that the reality may be viewed from either a user viewpoint or the viewpoint of a device which is detached from the user.

### OBJECTS AND ADVANTAGES

In view of the shortcomings of the prior art, it is an object of the present invention to teach systems and methods for providing a rich, pleasant and comfortable virtual reality, augmented reality or mixed reality experience to the user.

It is also an object of the invention to provide techniques for modifying the appearance of one or more virtual objects in a reality or environment viewed by the user. The reality is viewed by the user via a viewing mechanism, and the modification is based on one or more properties of an inside-out camera. The appropriate properties of the inside-out camera are suitably chosen according to the application at hand.

It is further an object of the invention to allow an array of choices for the properties based on which the above modification is performed. These choices include the pose of the camera, a reduced homography and any other property recoverable from the output of the camera.

It is further an object of the invention to allow for the user to view the reality from his/her own viewpoint or from the viewpoint of another device.

The numerous objects and advantages of the systems and methods of the invention will become apparent upon reading the ensuing description in conjunction with the appended drawing figures.

### SUMMARY

The objects and advantages of the present invention are secured by a system having a viewing mechanism, in which a user views one or more virtual objects in an environment or scene. The environment is viewed by the user from his or her viewpoint or vantage point. The system further employs a projection mechanism that projects or displays the environment that is viewed by the user via the viewing mechanism. There is an inside-out camera or more than one inside-out cameras with various properties that can be measured or recovered from its/their output. Then based on one or more such properties, the projection mechanism alters or modifies the one or more virtual objects in the environment viewed by the user from his/her viewpoint.

In the preferred embodiment, the environment or scene viewed by the user is preferably a virtual reality. In a variation, the environment is an augmented reality. In another related variation, the environment is a mixed reality. Preferably, the property of the inside-out camera based on which the one or more virtual objects in the scene/environment are modified for the user, is the pose (position and orientation) of the user. More specifically, it is the pose of the inside-out camera employed by the user, and the inside-out camera is used in the recovery of the pose. In a related embodiment, the property is a homography.

Preferably, the inside-out camera is mounted on or worn by the user. In another variation, the alteration or modification to the one or more virtual objects in the environment viewed by the user are done so as to reinforce or improve a perception of the presence of the user in a virtual reality. In a similar embodiment, the alteration or modification to the one or more virtual objects in the environment viewed by the user are done so as to reinforce/improve a perception of the presence of the one or more virtual objects in an augmented or mixed reality. In another variation, the alteration is done to correct the positioning of the one or more virtual objects in the environment viewed by the user from his/her viewpoint. In yet another variation, the alteration is done to enhance the information communicated to the user through his or her visual senses.

In still another variation, the alteration done by the projection mechanism to the viewed environment is consonant to a movement of the user. In a related variation, the alteration is done so as to minimize the motion discomfort or sickness of the user as a result of his/her movement and the corresponding changes needed to be made in the viewed environment. In another related variation, the movement of the user is constrained. The constraint on the movement of the user results in a reduced homography which is used as the property of the inside-out camera based on which the changes to the virtual object(s) in the environment are made.

In an advantageous set of embodiments, the alteration of the VR/AR/MR scene is done by the projection mechanism by changing the associated programmable and configurable parameters. Preferably these are the programmable and configurable parameters of the corresponding graphics rendering pipeline. More preferably still, these parameters are the vertex operations of the graphics rendering pipeline. It is yet more preferable, that these parameters be the fragment operations. In another variation, these parameters are the pixel-based operations of the graphics rendering pipeline. In still related embodiments, the parameters are model transformations, or view transformations or camera transformation of the graphics rendering pipeline. In still other related embodiments, these parameters are shading, diffusion and light-scattering effects applied to image fragments of the one or more virtual items being altered/modified.

In other advantageous embodiments, the inside-out camera is employed by a second user. In these embodiments the first user or set of users view the environment from the viewpoint of the second user. The inside-out camera(s) may preferably be mounted on or worn by the second user. The inside-out camera may preferably be affixed to the viewing mechanism, or it may be integrated with it, or connected to it or attached to it. Furthermore, the viewing mechanism may preferably utilize a display unit. The display unit may preferably be affixed to the viewing mechanism, or it may be integrated with it, or connected to it or attached to it. More preferably still, the display unit may be a heads-up display (HUD) or a head-mounted display (HMD). In another variation, the viewing mechanism may employ optics, and thusly be called viewing optics.

Preferably the viewing mechanism is replicated so that the environment is viewed in stereo by the user. More preferably still, the inside-out camera(s) and/or the projection mechanism are replicated for stereoscopically performing the alteration(s) and/or modification(s) of one or more virtual objects in the environment seen by the user from his/her viewpoint. As stated, the alteration/modification is done based on one or more properties of the inside-out camera(s).

In a highly preferred set of embodiments, the viewing mechanism is a virtual reality eyewear, an augmented reality eyewear or a mixed reality eyewear. In related embodiments, this eyewear is a set of goggles, eyeglasses, or even a telescope or binoculars.

In another set of preferred embodiments, the user employs a control device for performing the above mentioned alteration/modification to the VR/AR/MR scene. In one of these embodiments, the control device is worn by or mounted on the user. In another one of these embodiments, the control device is used to control the power or another signal delivered to the viewing mechanism and/or the inside-out camera. In still another embodiment, the control device is used to control the appearance of an image in the viewing mechanism. Preferably, the control device is a joystick, a game controller, a touch sensor, a gesture sensor (e.g. the ones used in games and smartphones), a digital pen (e.g. a stylus), a proximity sensor (e.g. a capacitive, photoelectric or inductive sensor), a vicinity sensor (e.g. using radio frequency identification (RFID) technology), an electromagnetic sensor, an inertial sensor (e.g. an accelerometer or a vibration sensor) or one of the many types of motion sensors.

In similar embodiments, instead of a control device, the system uses an auxiliary sensor for controlling the appearance/modification of the one or more virtual objects. Preferably, the auxiliary sensor is an optical sensor, an inertial sensor (e.g. an accelerometer or a gyroscopic sensor), a magnetometer, an optical flow sensor, a displacement sensor, an acoustic sensor, a Radio Frequency (RF) sensor.

In a highly preferred set of variations, the system employs a device which has the inside-out camera(s). Now, the viewing mechanism is used by the user to view the environment containing one or more virtual objects/items from the device viewpoint (instead of from the user viewpoint as in prior embodiments). Then based one or more properties of the inside-out camera(s) employed by the device, appropriate modification(s) and/or alteration(s) to the one or more virtual objects in the scene/environment are performed by the projection mechanism. All other teachings of the prior embodiments still apply to these variations, except that the environment now is viewed from the device viewpoint.

The device in the above embodiments may be controlled by the user, or it may be an autonomous or semi-autonomous device. The device may be a drone, a robot, a remotely controlled tool or implement, a remotely controlled automotive equipment, etc. The viewing mechanism and projection mechanisms may preferably be integrated with each other, and in fact be the same. The projection mechanism may preferably employ a display unit.

The display unit may be integrated in the device from whose viewpoint the environment is being seen by the user, or it may be affixed to it, attached to it, or operably connected to it. Similar to prior embodiments, the above mentioned alteration/modification to the scene (specifically the virtual objects in it), may be done consonant to a motion of the device. The motion of the device may preferably be constrained, resulting in a reduced homography. Generally, the device in these embodiments may be a manipulated device/item, i.e., it is moved or operated directly by the user (e.g., by hand), or the device is a wearable device, which is carried or worn by the user.

In still another set of embodiments, the system employs optical sensor(s) for imaging preferably non-collinear points in an environment that is viewed by a viewer. Another mechanism then layers one or more virtual objects onto that environment that is viewed by the viewer. These one or more virtual objects are then modified/altered by the above mechanism based on the tracking of the movements of the viewer by the system. The viewer is preferably a human whose discomfort is minimized. In an alternative variation, the one or more virtual items may be modified/altered based on one or more properties of the optical sensor(s). Preferably, the optical sensor(s) is/are embodied in an HUD/HMD. Preferably, the optical sensor(s) are affixed to a gear that is mounted on, manipulated by or worn by a user.

The methods of the invention further provide the steps required to accrue its benefits. Specifically, the methods provide for layering of one or more virtual objects by a projection mechanism onto an environment viewed by a viewer from its viewpoint. Then appropriate modifications to the one or more virtual objects may be performed based on one or more properties of an inside-out camera. The inside-out camera may be mounted on or worn by the viewer.

According to the methods, in a preferred embodiment, the environment seen by the viewer is a virtual reality scene, an augmented reality scene or a mixed reality scene. The property (or properties) based on which the above modification/alteration of the one or more virtual objects is done is preferably a pose, a homography, or other properties recoverable/measurable from the output of the inside-out camera.

According to the methods of the invention, the viewer is preferably a sentient being such as a human or an animal. The viewer may also preferably be a machine or a device such as a drone, a robot, a manipulated tool, a remotely controlled tool, a remotely controlled implement, a remotely controlled automotive equipment, or an artificially intelligent agent. As in prior embodiments, the alteration/modification of the virtual object(s) in the scene is preferably consonant with the motion of the viewer.

The above motion of the viewer is preferably constrained, resulting in a reduced homography, rather than a full or regular homography.

This is preferably because of the presence of structural uncertainties in the optics of the viewing mechanism, or because of structural redundancies caused by the conditioned motion of the viewer.

The specifics of the invention and enabling details are described below with reference to the appended drawing figures.

### DESCRIPTION OF THE DRAWING FIGURES

FIG. 1A illustrates an environment/scene projected on the display of a smartphone. The environment as projected comprises both real and virtual objects.

FIG. 1B shows the Mixed Reality continuum extending from real environments to purely virtual environments.

FIG. 2 shows a variation of FIG. 1A where the smartphone is accommodated into a head-mounted display and where the projected/displayed environment consists of left and right eye views for stereo vision of the user.

FIG. 3A shows another environment projected onto augmented or mixed reality eyeglasses having inside-out cameras. The projected environment comprises both real and virtual objects.

FIG. 3B shows a representation of an eye behind the eyeglasses of the embodiment of FIG. 3A.

FIG. 4 shows the 6 degree of freedom (6 DOF) available to a human user (specifically his/her head), who is wearing the eyeglasses of FIG. 3A.

FIG. 5A-B illustrate the canonical position of the head of the user of FIG. 4, or more simply just the canonical position of the user of FIG. 4, viewing a virtual object in an environment comprising both real and virtual objects.

FIG. 6A-B show the Yaw rotation of the user from his/her canonical position in FIG. 5A-B, and the respective change to the virtual object normally expected by the user in the seen environment.

FIG. 7A-B show the Pitch rotation of the user from his/her canonical position in FIG. 5A-B, and the respective change to the virtual object normally expected by the user in the seen environment.

FIG. 8A-B show the Roll rotation of the user from his/her canonical position in FIG. 5A-B, and the respective change to the virtual object normally expected by the user in the seen environment.

FIG. 9A-B illustrate the canonical position of the user of FIG. 4 viewing a virtual object in an another environment comprising both real and virtual objects.

FIG. 10A-B show the translational movement of the user along X-axis from his/her canonical position in FIG. 9A-B, and the respective change to the virtual object normally expected by the user in the seen environment.

FIG. 11A-B show the translational movement of the user along Y-axis from his/her canonical position in FIG. 9A-B, and the respective change to the virtual object normally expected by the user in the seen environment.

FIG. 12A-B show the translational movement of the user along Z-axis from his/her canonical position in FIG. 9A-B, and the respective change to the virtual object normally expected by the user in the seen environment.

FIG. 13 is a sketch of a human user in the canonical position, wearing a head-worn VR/AR/MR gear. The human sketch consists of a head and a torso and the respective pivot points.

FIG. 14 shows the Yaw rotation of the head of the user with respect to the canonical position of FIG. 13, compounded by the forward/backward rotation of the torso around Y-axis.

FIG. 15 shows the Pitch rotation of the head of the user with respect to the canonical position of FIG. 13, compounded by the forward/backward rotation of the torso around Y-axis.

FIG. 16 shows the Roll rotation of the head of the user with respect to the canonical position of FIG. 13, compounded by the inward/outward rotation of the torso around Y-axis.

FIG. 17 shows the Yaw rotation of the head of the user with respect to the canonical position of FIG. 13, compounded by the leftward/rightward rotation of the torso around Z-axis.

FIG. 18 shows the Pitch rotation of the head of the user with respect to the canonical position of FIG. 13, compounded by the inward/outward rotation of the torso around Z-axis.

FIG. 19 shows the Roll rotation of the head of the user with respect to the canonical position of FIG. 13, compounded by the leftward/rightward rotation of the torso around Z-axis.

FIG. 20A-B illustrate the window method of viewing an environment comprising of real and virtual objects. The example illustrated uses the screen of a tablet device for the window method.

FIG. 21A-C illustrate how a real wine glass from the environment illustrated in FIG. 20A-B may be filled with virtual wine to render a virtually filled wine glass.

FIG. 22 illustrates the line of sight and left and right eye view axes of a user wearing the eyeglasses of FIG. 3A to view a wine glass in yet another environment.

FIG. 23A-C illustrate how the wine glass of FIG. 22 may be seen by the user when the optometry/parallax problem is not addressed, poorly addressed and properly addressed respectively.

FIG. 24 shows what the user of FIG. 22 would see in his/her left and right eye views of the eyeglasses while viewing the wine glass.

FIG. 25 illustrates yet another environment comprising real and virtual objects. The example illustrated shows the user wearing the eyeglass of FIG. 3A driving a car through which he/she observes the environment projected onto the windscreen and/or onto the optics of the eyeglasses.

FIG. 26 shows the left and right fields of view of the user from an embodiment of FIG. 25 while seeing objects in the near field and while seeing objects far away (i.e. when he/she is “focused at infinity”).

FIG. 27A-B illustrate another view of the objects in the near field and far away as observed by the user of FIG. 26.

FIG. 28A shows the generic implementation of a graphics rendering pipeline, showing fixed functionality with solid line boxes, configurable functionality with dot-and-dashed line boxes, and programmable functionality with dashed line boxes.

FIG. 28B shows a simplified implementation of the graphics rendering pipeline as provided by OpenGL.

FIG. 28C shows the four transformations typically involved in a graphics rendering pipeline: model, view, camera and viewport.

FIG. 29 illustrates the user wearing the headworn gear of FIG. 2 for observing yet another environment but this time from the viewpoint of a remotely controlled device which is a drone in the example shown.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

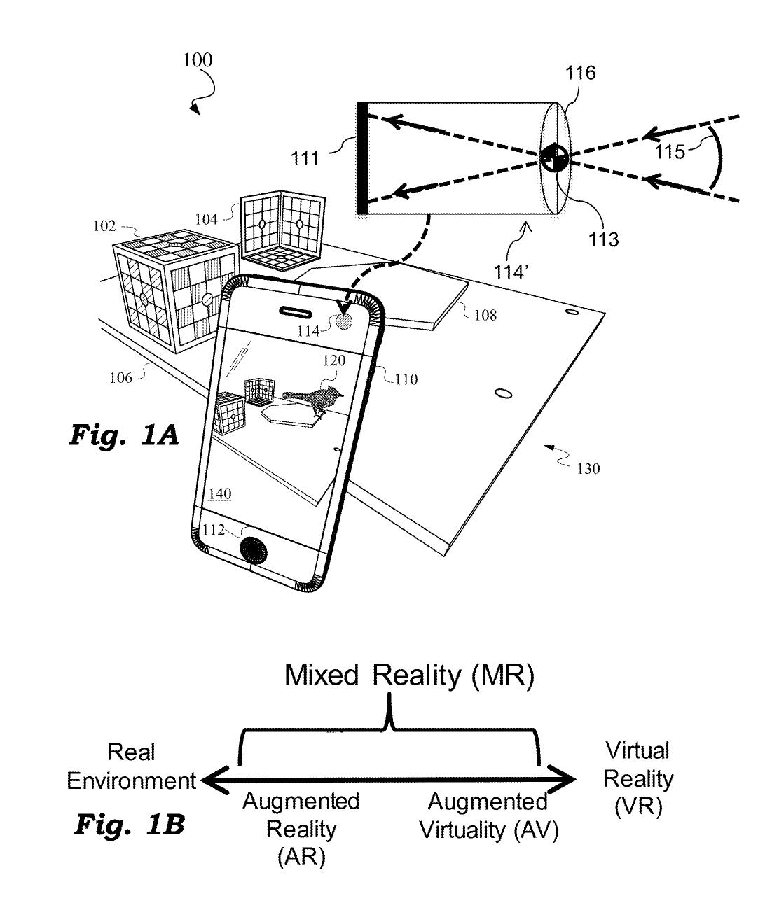

The various aspects of the invention will be best understood by initially referring to system 100 containing an environment 130 as shown in FIG. 1A. Environment 130, which could be indoor or outdoor, comprises real world objects which could be any objects. In the example shown in FIG. 1A two such objects 102 and 104 are shown and these objects are two cubical dices. Object 106 is a plate or a platform and object 108 is another plate or platform smaller in size than plate 106 and placed on top of it.

Environment 130 also shows a mobile phone 110 with a viewing mechanism or screen or display 112 and an inside-out camera 114. The schematic diagram of camera 114 is shown as 114′. Schematic 114′ illustrates how camera lens 116 projects the images of real world objects 102, 104, 106 and 108, or any other objects that may lie within the camera's angular field-of-view 115 onto photo-sensor 111. These objects are projected through a single viewpoint 113 of camera 114. Objects 102 and 104 are configured to contain features convenient for calculating the pose of camera 114 with respect to the stable environment 130.

The pose thus recovered may then be used to alter the appearance of virtual object 120 to correspond with any changes occurring in the pose of camera 114 as mobile phone 110 is moved by the user to different poses within stable environment 130. It should be noted that while the present embodiment depicts a single viewpoint 113, the present invention is capable of working with similar embodiments in less than ideal conditions of a strictly single viewpoint. In other words, the present teachings, and the pose recovery techniques of the related references that the present invention utilizes, can work in the presence of some image aberration if viewpoint 113 was a little “smeared out”.

Although inside-out-camera 114 in the example shown in FIG. 1A is embodied into mobile phone 110, the invention admits of any other type of camera, professional or amateur, stand-alone or otherwise, that is capable of performing the functions of an “inside-out” camera as will be explained further below. Similarly, viewing mechanism 112 of mobile phone 110 is its display unit/screen, however in alternative embodiments the invention admits of having any other type of viewing mechanisms, including eyewear and lenses as will be further taught below.

As shown in FIG. 1A, environment 130 is projected/displayed on viewing mechanism 112 of mobile phone 110 having inside-out camera 114. It should be noted that camera 114 is facing the far side of mobile phone 110 as indicated by its hatched pattern i.e. it faces real world objects 102, 104, 106, 108 and into the page of FIG. 1A.

Environment 130 can also have any number of virtual objects. In the example of FIG. 1A one such virtual object 120 is shown. Virtual object 120 can be any object that is viewed on display 112 by the user (not shown) from the camera's viewpoint or vantage point. In the example shown in FIG. 1A, virtual object 120 as viewed on display 112 by the user (not shown) from viewpoint 113 of inside-out camera 114, is a bird.

As shown in FIG. 1A, virtual bird 120 is layered onto environment 130 on display unit/screen 112 of phone 110, and is displayed/projected as composite environment or rendering 140. We refer to composite environment 140 comprising of real world objects 102, 104, 106, 108 and at least one virtual object 120, as an augmented/mixed reality scene/image/environment/reality 140. Although one such virtual object 120 is used in the present example, the invention admits of any number and types of virtual objects present in the augmented/mixed reality scene/image/environment/reality 140.

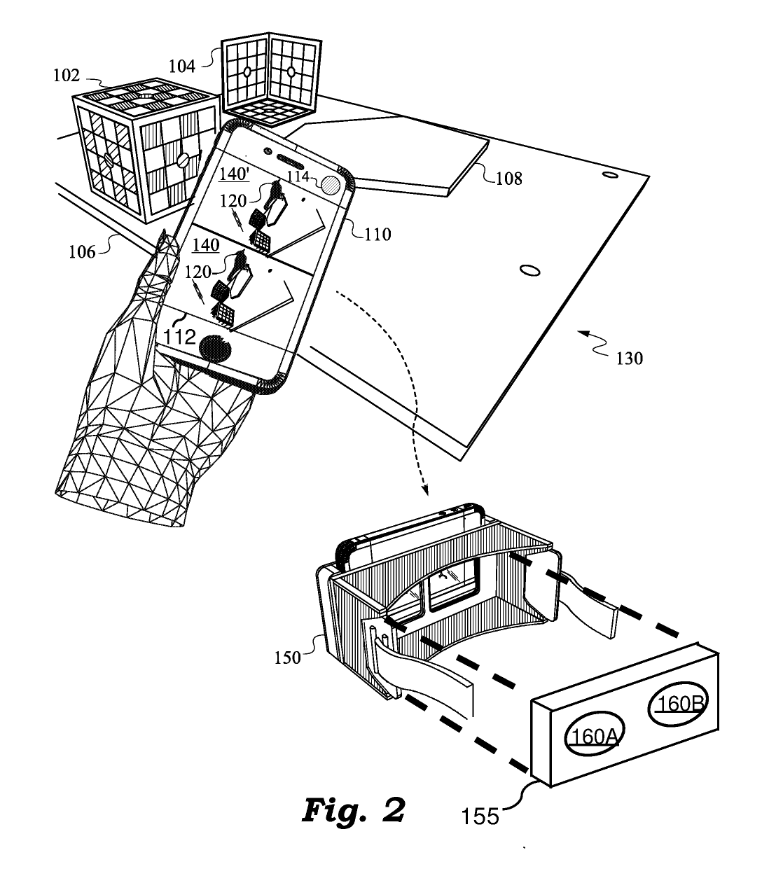

As will be further explained below, the mixed reality scene may be viewed from two viewpoints of reality 140 illustrated in FIG. 2, one without the prime “′” for the left eye i.e. 140 and one with the prime i.e. 140′ for the right eye. Since environment 140 and 140′ are actually rendered onto display 112 and are thus properly considered as renderings. For clarity in this disclosure we will use the term environment or scene or reality to refer to these and other such renderings, or use the terms interchangeably where convenient.

The above two viewpoints for the left and right eyes may be created synthetically by knowing the positions of the user's eyes with respect to the inside-out camera's viewpoint 113. Then optical projection system 155 (shown disassembled from head-mounted display (HMD) 150) is used to project the image information from two viewpoints emanating from different regions of display 112 onto the user's respective retinas. In some cases, optical system 155 may simply comprise two lenses 160A and 160B as shown in FIG. 2. Lenses 160A and 160B are positioned between the display and the user's eyes, thereby producing focused images of the respective regions of the display associated with each eye onto the user's left and right retinas.

It should be noted that in the above example, even though smartphone 110 has only one camera 114, we are still rendering both left and right images in the display via the two synthetically created viewpoints. Virtual objects, such as virtual object 120, can be rendered correctly in both the left and right display, but the real scene is captured only through viewpoint of camera 114. This may not be sufficient for creating a ‘true’ stereo image. In order to render the real world objects for a true stereo vision, one must have two cameras corresponding to left and right eyes, or camera 114 must capture depth information, image disparity or a similar property allowing stereoscopic rendering.

Thus camera 114 can be a stereo camera or depth camera. Alternatively, camera 114 can be a conventional camera capturing a sequence of images of the same scene from slightly different viewpoints. Indeed, in an interesting variation of the embodiment shown in FIG. 2, instead of one camera 114, smartphone 110 has two cameras placed apart the same distance as average human eyes i.e. at an average inter-pupillary distance. Such a variation will be able to produce a true stereo vision for the user.

A second inside-out camera may also be employed to increase the collective field-of-view for gathering the images of real world objects. Additionally, the second inside-out camera may be used for providing auxiliary pose information that may be required in cases when the particular real world objects that contain features convenient for calculating the pose (i.e., objects 102 and 104) lie outside the field-of-view of the first inside-out camera.

As understood in the art, a mixed reality (MR) refers to a system that combines real and virtual objects and information that may be fused or layered together to give the viewer an enhanced viewing experience, compared to just the virtual reality or purely real or real reality environments. As shown in FIG. 1B the “mixed reality continuum” extends from a purely real environment to a purely virtual environment. A given scene/image/environment/reality may be purely real when no augmentation/virtuality is present, to augmented reality (AR) when some augmentation/virtuality is present to augmented virtuality (AV) when even more augmentation/virtuality is present (i.e. when real objects are superimposed onto an otherwise virtual scene) to purely virtual reality (VR) when the scene/image/environment/reality becomes purely virtual.

As used in this disclosure the terms scene, environment, image, rendering and reality may be used interchangeably to represent a scene or a sequence of scenes being observed by a user of the system, and any distinction will be drawn as and if needed. Also, the distinction between VR, AR, MR may be drawn only as needed knowing that the principles of the invention apply to any scene or environment observable through a viewing mechanism in concert with inside-out camera(s) and associated elements of the system as taught in this disclosure.

Recovering three dimensional (3D) pose (position and orientation) of manipulated, worn or remotely controlled objects is a hard problem. There are two approaches that choose fundamentally different camera placements to achieve this purpose. The outside-in camera method places camera(s) in the environment to track the user's/viewer's VR/AR/MR gear. The inside-out camera method places one or more cameras on the user's/viewer's VR/AR/MR gear to track the pose of the user/viewer based on the same rules of perspective geometry as humans apply naturally.

The pose of the inside-out camera can be recovered from certain features of objects in the environment that lie within the field-of-view of the inside-out camera. The pose of the inside-out camera can then be transformed into a new pose corresponding to a different camera orientation and/or a different camera position. That is often useful for projecting virtual images onto a user's retina corresponding to the different viewpoints of each the user's eyes while viewing a scene.

For systems having stereoscopic displays (i.e. using a different region of the display for each eye), it is useful to know the position and orientation of the user's eyes (i.e. the pose of each eye) with respect to the pose of the inside-out camera. That is in order to facilitate the calculations of the absolute pose of each eye (with respect to the environment), and for projecting virtual objects that are displayed properly to each eye for stereoscopic vision of the virtual objects.

The above can be accomplished by coordinate transformations that take advantage of the knowledge of the spatial relationships between the inside-out camera and the user's eyes. In some cases, multiple inside-out cameras may be used to provide a larger combined field-of-view (i.e., one inside-out camera facing forward and a second inside-out camera facing backward) to insure that real world objects having certain features convenient for recovering pose are always within the field-of-view of at least one of the inside-out cameras. With the inside-out camera techniques as employed by the instant invention, instrumentation of the environment is not a requirement.

For a detailed treatment of pose recovery techniques using an inside-out camera, the reader is referred to U.S. Pat. No. 7,826,641, U.S. Pat. No. 7,961,909, U.S. Pat. No. 8,553,935, U.S. Pat. No. 8,897,494, U.S. Pat. No. 9,235,934, U.S. patent application Ser. No. 14/992,748, U.S. Pat. No. 8,970,709, U.S. Pat. No. 9,189,856 and U.S. patent application Ser. No. 14/926,435.

According to the main aspects, virtual item 120 in FIG. 1A as viewed from viewpoint 113 of inside-out camera 114 of system 100, may be altered based on one or more properties of inside-out camera 114. These properties Among such properties is preferably the pose (position and orientation, also sometimes referred to as the extrinsic parameters) of camera 114 with respect to stable environment 130. The user of system 100 is presumed to be looking at viewing mechanism or display unit/screen 112 of phone 110 using normal vision (i.e., naked eye and optionally any corrective eye glasses or contact lenses) while phone 110 is being held in the user's hand. In subsequent description of the embodiments, any prescriptive/corrective eye glasses or contact lenses of the user will be presumed to exist and be appropriately worn by the user, and thus will not be explicitly illustrated or referenced for clarity.

Since in FIG. 1A, camera 114 is integrated with mobile/smart phone 110, the property is preferably the pose of mobile phone 110 itself. The altering of virtual object/image 120 based on the pose of camera 114 or mobile phone 110 is of great importance. That is because depending on that pose, a suitable modification of virtual object 120 (or other virtual objects if present) may be warranted, desired or required. Many examples of such alteration or modification are possible.

Note further that throughout this disclosure when referring to such alteration or modification or correction or adjustment or compensation, we may use the noun in the singular with the understanding that more than one such alterations or modifications or corrections or adjustments or compensations to the images/scenes may be made based on one or more properties of the inside-out camera(s). These properties may encompass extrinsic parameters of the inside-out camera(s) i.e. orientation and pose, its intrinsic parameters i.e. focal length fₓ, f_{y}, optical center (x₀,y₀) and axis skew, as well as many other properties that will be taught later in this specification.

Now recall the embodiment of FIG. 2 introduced earlier, employing a VR/AR/MR headset or heads-up display (HUD) or head-mounted display (HMD) 150 that can accommodate smart phone 110 of FIG. 1A. There are a variety of such headsets available in the market that can accommodate a smart phone. They typically include optical projection system 155 (shown disassembled from HMD 150) comprising projection lenses 160A and 160B. Lenses 160A-B focus image information emanating from the two respective regions of the smart phone display onto each of the user's respective retinas.

The result is either a VR experience, or in conjunction with the phone's camera an AR or MR experience for the user. A non-exhaustive list of such headsets includes Google Cardboard, Freefly, VR One, ColorCross, etc. As in the case of the embodiment of FIG. 1A, the appearance of virtual object 120 in FIG. 2 may be altered or adjusted based on one or more properties of inside-out camera 114 (e.g. some or all of its extrinsic or intrinsic parameters, or still other properties taught below). Such adjustment(s) may be made in projected environments 140 and 140′ respective to the left and right eyes of the user.

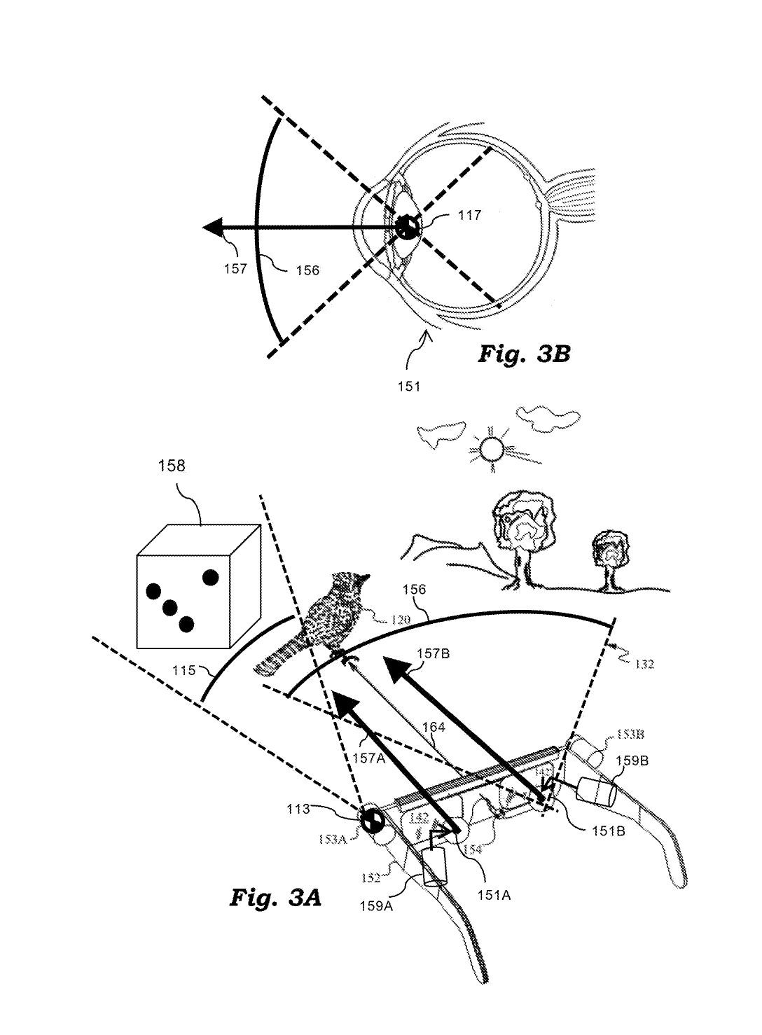

In addition, a variety of other higher-end wearables are also available in the market that comprise the entire optical and electronic circuitry to provide a complete VR/AR/MR experience, without requiring a smart phone or handset. A non-exhaustive list of such eyewear products includes the Oculus Rift, Sony PlayStation VR, HTC Vive Pre, ODG R-7 Smart Glasses, Microsoft HoloLens, FOVE VR, Avegant Glyph, etc. An example of such an integrated HUD/HMD 152 is shown in FIG. 3A in which an environment 132 is being viewed.

Note, that since environment 132 is actually also seen through the optics of eyeglasses 152 onto which virtual object(s) are projected, as such the eyeglasses 152 would typically be characterized as AR/MR glasses, rather than VR glasses. The latter typically do not require and have a “see through” capability. Such a capability is also sometimes referred to as “Optical see-through” capability in the art. A related capability called “Camera see-through” in the art is sometimes used to refer to a VR setup where two cameras are used to provide binocular vision for the user of the environment, and onto which virtual objects may be layered.

However, to avoid undue detraction from the teachings of this disclosure, we will consider eyeglasses 152 to be VR, AR and/or MR (or more simply VR/AR/MR), while knowing the above subtle difference and distinguishing as and if necessary. Moreover, one could conceive of eyeglasses 152 to be VR type as well, if the see-through capability is blocked and the entire scene projected onto the user's retinas is virtual.

Device 152 in FIG. 3A has two inside-out cameras 153A and 153B. Inside-out camera 153A has an angular field-of-view 115 that is capable of gathering images of real world objects, such as real object 158. Object 158 is configured with features that are convenient for recovering the pose of inside-out camera 153A with respect to real world object 158. Inside-out camera 153B would also have its corresponding angular field-of-view, however it is not shown in FIG. 3A for clarity.

Images 142 and 142′ are projected onto the retinas of eyes 151A and 151B respectively by image projectors (i.e., pico-projectors) 159A and 159B. The complete projection system of device 152 also includes the eyeglass lenses that provide see-through capability. As indicated by the two respective angled arrows, they also act as reflectors for deflecting the image information emanating from projectors 159A and 159B into eyes 151A and 151B respectively.

By employing the techniques taught in the above mentioned references, once the pose of inside-out camera 153A with respect to stable environment 132 is established, then the pose of the user's left and right eyes 151A and 151B respectively can also be calculated. This can be accomplished by familiar coordinate transformations derived using known spatial relationships of inside-out cameras 153A-B and user's eyes 151A-B. These relationships may be established by the specific design specifications of the head-mounted display (HMD). The accuracy and fidelity of the projected environment may be further improved by using eye-tracking hardware that utilize techniques well known in the art of HMD design.

A representation of the user's eye 151 is shown in FIG. 3B. The pose of user's eye 151 in FIG. 3B is represented by arrow 157 that is terminated at viewpoint 117, which is shown to be located near the center of the eye's lens. Arrow 157 and viewpoint 117 thus represent the orientation of the eye's optical axis and the position of the eye's viewpoint respectively, and together this orientation and location serve as a representation of the eye's pose. Similar to

FIG. 3B, the corresponding poses of left and right eyes 151A and 151B in FIG. 3A are shown as arrows 157A and 157B respectively.

Each user eye 151A, 151B also has a natural angular field-of-view 156, which allows viewing of real world objects in environment 132 that lie within this angular field-of-view range. Note for clarity in FIG. 3A that the angular filed-of-view 156 of only right eye 151B is shown. Also shown in FIG. 3A are real world objects in environment 132 that are located within angular field-of-view 156. These real world objects can be seen in their natural locations by eye 151B when looking directly through the “see-through” eyeglass lenses. Specifically, real world objects include block 158 and the trees, mountains, clouds and the sun. Meanwhile bird 120 is a virtual object.

Projector 159B projects a virtual image of virtual bird/object 120 onto the retina of eye 151B, thereby producing a composite viewing of both real and virtual images on the user's right retina. This is an example of augmented reality (AR), whereby virtual objects are projected on the retina having the appearance of a real world object. The same process is replicated for left eye 151A through the use of projector 159A. The result is an Optical see-through capability introduced earlier.

In an alternate variation of this AR/MR system, the eyeglass lenses may be opaque, thus not allowing eye 151B to directly view the real world objects in environment 132. Instead, the images of the real world objects are gathered by camera 153B and projected by projector 151B onto the retina of eye 151B in the same location, and with same or altered appearance as compared to when the eye is directly viewing through a transparent eyeglass. The same process is repeated for left eye 151A by employing camera 153A and projector 159A.

The result is a Camera see-through capability introduced earlier. Moreover, virtual object 120 can be simultaneously projected onto the retina to produce a mixed reality experience for the user. This is an example that represents a case of augmented virtuality (AV), whereby real world objects are projected on the retina having the appearance of virtual objects. Both of these cases described above represent different versions of mixed reality (MR) systems.

The rendered scenes 142 and 142′, projected by projectors 159A and 159B onto the left and right panes of eyeglasses 152 respectively, are slightly different, each corresponding to the vision of one eye of the user. Rendered scenes 142 and 142′ may include unaltered portions of the captured images, or they may be further corrected/processed using knowledge of the actual pose of each eye 151A, 151B using known dimensional properties of headwear 152.

Having multiple cameras further facilitates in the quick and accurate recovery of user/camera pose using the techniques taught in the above references. However, the invention admits of having just a single inside-out camera for pose recovery (typically situated at the center of the eyeglasses at or slightly above the center of eyes of the user). Therefore, in subsequent drawings we may not explicitly label cameras 153A and 153B with the admission that one or multiple such cameras may be present on the wearable used by or mounted on the user.

In these and other related embodiments, the invention employs a projection mechanism, which is actually responsible for displaying/projecting the VR/AR/MR scenes/environment onto the retinas of the user's eyes as the user views the VR/AR/MR scenes/environment. The projection mechanism may employ appropriate hardware and software technologies to generate the requisite scenes and images that are seen by the user via the viewing mechanism.

Often times, the viewing mechanism and the projection/display mechanisms are integrated and/or are one and the same. In other words, the display unit/screen of the projection mechanism is the same as the viewing mechanism used by the user to view the VR/AR/MR scenes. That is the case with HUD/HMD 150 of FIG. 2 where a smartphone's display is used as the viewing mechanism as well as the screen onto which the projection mechanism renders the VR/AR/MR scenes.

In the case of eyeglasses 152 of FIG. 3A, the projection mechanism also employs pico-projectors 159A-B in conjunction with partially-reflecting mirrors built into the eyeglasses. Viewing mechanism consists of the eyeglasses having see-through capability and are configured to project images and information through each eye onto the respective retinas, thereby providing the user with an AR/MR experience.

Having such a setup of integrated viewing and projection mechanisms, is typical of smartphones, tablets, eyewear and many other devices employed in these teachings where the screen/window onto which the environment is displayed is also the same screen/window viewed by the user. A viewing mechanism is any facility or capability of viewing the VR/AR/MR environment, while the projection mechanism is responsible for performing graphics rendering and the associated computations, and adjustments/alterations/corrections to the virtual objects/scene of the VR/AR/MR environment being viewed. These adjustments are based on one or more properties of the inside-out camera(s) as explained throughout this disclosure.

As such, the projection mechanism may not be explicitly illustrated in the drawing figures nor explicitly referenced in associated teachings, but is presumed to exist and be integrated with, affixed to, attached to or operably connected with the viewing mechanism/display. As stated, it is responsible for generating the images and any adjustments to the images according to the invention that are seen by the user via the viewing mechanism, and as also stated the two mechanisms are often integrated in practice.

It should be noted that having an imaging and rendering system that employs a lens or optics is not an absolute requirement for pose recovery. In alternative setups photosensor(s) may be used “bare” to register photons without an intervening lens or optics. With appropriate light modulation utilizing techniques known in the art, pose recovery can be accomplished using the techniques taught in the above mentioned references. In other words, although having an imaging system is useful and often required to project the scene/reality to a viewer, that is not a requirement for pose recovery. As such, the principles of this invention apply well to any VR/AR/MR apparatus, whether or not it employs any lensing or optics.

Returning to FIG. 3A, the illustration also shows an alternative vantage/viewpoint 154 that represents the viewpoint of an alternatively placed inside-out camera (not shown) that would be centrally located in the glasses 152 from which the user performs the above viewing. This alternative configuration could be provided by simply repositioning inside-out camera 153A to this new centrally located position. In this case, the pose of a centrally located inside-out camera is represented by the combination of viewpoint 154 and the solid arrow 164 shown extending from viewpoint 154, and indicating a position and orientation that is associated with the centrally located inside-out camera's pose.

For clarity, in subsequent descriptions of the invention, we will mostly use this simplified configuration to illustrate different uses of VR/AR/MR glasses. This configuration will have a centrally located inside-out camera used for pose recovery, and for gathering images of real world objects to be displayed or projected onto the user's retinas for viewing an VR/AR/MR environment. In FIG. 3A such an alternatively located inside-out camera is not shown, but is instead represented by viewpoint 154 and orientation 164, which together represent the camera's pose. Also, the specifics of this centrally located inside-out camera such as lens design, photo-sensor type, field-of-view, etc. may not be explicitly described in subsequent illustrations/figures of the invention, since many different designs of inside-out cameras may be used and are known in the art.

The principles of the invention apply well to any device whether it be just a wearable headset that can accommodate a handset device such as an iPhone or an Android phone, or whether it be a fully functional wearable device without requiring the insertion of a handset. In FIG. 2, environment 130 is projected along with a virtual object 120 onto environment 140/140′ on the mobile phone's display unit 114. Note that several of the reference numerals from FIG. 1A have been omitted in FIG. 2 for clarity. Note further that AR/MR environments 140/140′ and 142/142′ of FIG. 2 and FIG. 3A respectively, provide for a stereo vision for the user. Specifically, realities 140 and 142 correspond to the left eye of the user in FIG. 2. and FIG. 3A respectively, and their slightly different counterparts 140′ and 142′ correspond to the right eye of the user in FIG. 2 and FIG. 3A respectively.

In related systems of the prior art, without appropriate adjustments or compensation to the image/scene viewed by the user, a discomfort motion sickness is normally induced in the user due to his/her or camera's motion. In the embodiment shown in FIG. 2 where camera 114 integrated with phone 110 is mounted on or worn by the user, and in the embodiment shown in FIG. 3A where eyeglasses 152 are worn by the user, the motion sickness may be due to the motion of the user himself/herself.

Motion sickness or discomfort is a common problem in such VR/AR/MR systems of the prior art because they fail to compensate for the movement of the camera and consequently its changing pose to make appropriate corrections to the projected images/scenes. Specifically, they fail to make appropriate alterations/corrections/adjustments to virtual object 120 (or other virtual objects if present) in FIG. 2, in response to the changing pose (position and orientation) of camera 114 on phone 110. Similarly, they fail to make appropriate alterations/corrections/adjustments to virtual object 120 (or other virtual objects if present) in FIG. 3A, in response to the changing pose (position and orientation) of the inside-out cameras 153A and 153B of eyeglasses 152.

In the examples of FIG. 2 and FIG. 3A, this motion would be due to the movement of user's head on which headset 150 or 152 is worn or the movement of the lower body or torso of the user as will be explained further below. This motion may be executed intentionally by the user. Alternatively, the user may make unintentional movements naturally associated with the face, neck, shoulder and lower body joints and muscles of the user. In the preferred embodiment of the invention, virtual object 120 (or other virtual objects if present) is/are altered to minimize the motion sickness for the user in response to his/her and/or camera's changing pose.

Those skilled in the art will understand that in the context of the present applications, a feeling of unease or discomfort, customarily called motion sickness, is attributed to the conflicts that occur between the human vestibular system and the human visual or ocular system. This motion sickness is especially a problem in AR/MR environment because of the need for a realistic integration of real and virtual objects, particularly in the near-field i.e. less than 10 feet away. As the distance increases and human eyes are more and more focused at infinity, the objects appear to move less with increasing distance, and the problem is minimized. Also, sometimes in a pure VR environment such as games, blurring and fog effects on near-field objects are used to trick the eyes into focusing on just the ‘active’ objects in the field. But this is an unnatural effect, because in actual reality, real fog blurs far away objects more so than close ones.

However, for AR/MR applications, especially in the near-field, the vestibular-visual delay can cause a serious conflict between the vestibular and visual/ocular inputs of the brain if the image is not corrected for head/camera motion. There is a partial conflict when the image correction is inaccurate, but it is also the time delay (latency) between the motion of camera 114 on phone 110 (see FIG. 2) and corresponding corrected image 120 of scenes 140 and 140′ viewed by the human visual/ocular system.

In order to remove the above motion sickness from VR/AR/MR scenes for objects in the near-field, the system must meet the following minimum requirements:
1) It should provide a response to changes in both the orientation and position (pose) of the camera as needed. The changes/corrections to the image/scene need to be consonant with the motion of the camera.
Of course in cases, where the camera is worn/mounted by the user e.g. eyewear, heads-up display (HUD) or head-mounted display (HMD), then the above consonance needs to be with the motion of the user's head.
2) The image correction for the rotational motion of the camera or user's head should have high accuracy (error less than −0.1 degrees) and low latency (motion-to-photons latency less than 10 milliseconds).
3) The image correction for objects for the translational motion of the camera or user's head should have high accuracy (error less than −3 centimeters) and low latency (motion-to-photons latency less than 10 milliseconds).
4) The refresh rate of the display where the image is projected should be at least 120 frames per second.

The present invention is able to achieve the above objectives because it is able to accurately and rapidly determine the pose of camera 114 and phone 110 (and that of the user's head/face for the embodiments of FIG. 2) and make appropriate adjustments to scenes 140 and 140′. Similarly, the present invention is able to accurately and rapidly determine the pose of the camera(s) on eyeglasses 152 (and that of the user's head/face for the embodiments of FIG. 3A) and make appropriate adjustments to scene scenes 142 and 142′.

These adjustments can be accurately made only if the pose of the viewer/user can be determined accurately and quickly using the available computing resources. Once the pose is determined on a near real-time basis by employing the techniques taught in above provided references, the projection mechanism can provide corrections to virtual object 120 or virtual objects if present, quickly enough so as to make the brain perceive a smooth and immersive VR/AR/MR experience.

Sometimes, a real object in an environment may be “cloaked” or made to disappear in an AR/MR scene by superimposing or cloaking it with a virtual object. The examples of this disclosure easily extend to such scenarios also, as will be obvious to a reader of average skill.

Again, such cloaking can only be effectively possible if the pose of the user/camera can be determined quickly and accurately while providing the VR/AR/MR experience to the user.

Techniques for recovering the pose of the camera, devices and viewers having six degrees of freedom (6 DOF) in a variety of settings have been extensively taught in related patent references. For a detailed treatment of pose recovery of a variety of viewers and/or optical apparatuses/objects, the reader is referred to U.S. Pat. No. 7,826,641, U.S. Pat. No. 7,961,909, U.S. Pat. No. 8,553,935, U.S. Pat. No. 8,897,494, U.S. Pat. No. 9,235,934, U.S. patent application Ser. No. 14/992,748, U.S. Pat. No. 8,970,709, U.S. Pat. No. 9,189,856 and U.S. patent application Ser. No. 14/926,435.

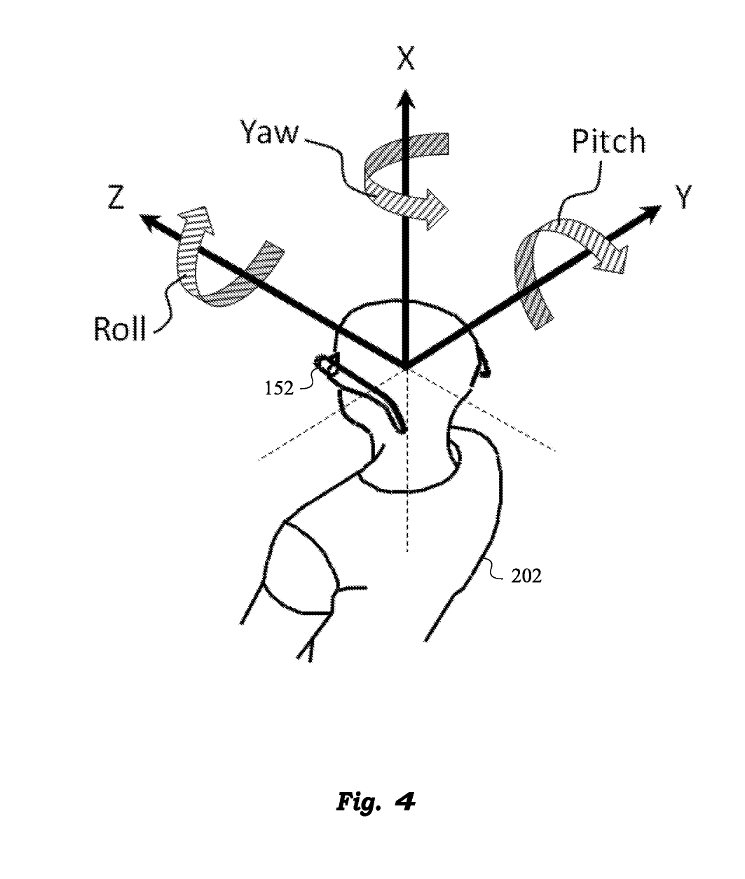

FIG. 4 shows the 6 DOF available to a viewer in a typical VR/AR/MR environment. In FIG. 4, user 202 wearing eyeglasses 152 of FIG. 3A having viewing optics and inside-out cameras attached to it can move his or her head along with eyeglass 152 in one or more of the 6 DOF shown. Specifically, this movement can be along one or more of 3 translational degrees of freedom represented by X, Y, Z-axes, and rotated about one or more of the 3 rotational degrees of freedom represented by a Yaw (φ) around X-axes, a Pitch (θ)around Y-axis and a Roll (ψ) around Z-axis.

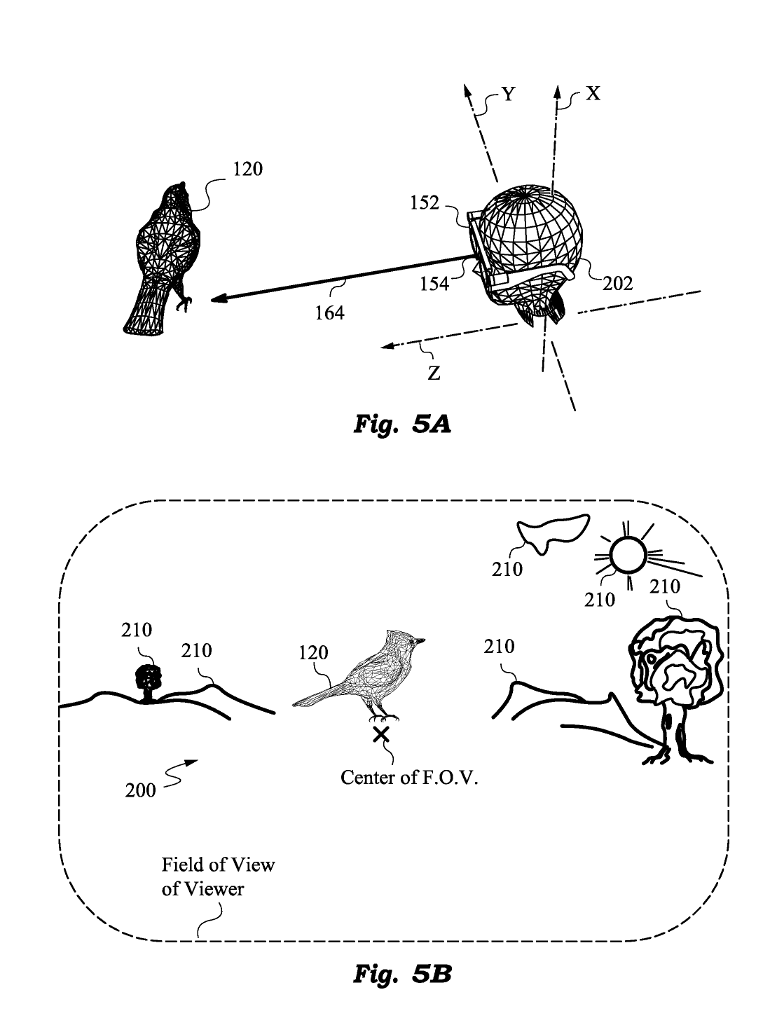

Let us now analyze what happens to the virtual object(s) projected by the projection mechanism of VR/AR/MR eyeglasses 152 in FIG. 4 on its display units/lenses. Note that in this and subsequent illustrations, the projection and/or viewing mechanism/lenses may not be explicitly shown and labelled for clarity and are of course presumed to exist in/on or be connected to device 152. As user 202 moves his or her head along the 6 DOF in FIG. 5A, he/she observes through glasses 152 a virtual object 120. The system of device 152 further performs pose recovery of the head of user 202 and that of glasses 152, using a centrally located inside-out camera (not shown) having a viewpoint 154 and orientation 164.

The viewpoint location 154 and orientation 164 of a centrally located inside-out camera (not shown) represents the pose of the inside-out camera and thus also represents the pose of eyeglasses 152. FIG. 5B represents an environment 200 viewed by user 202 of FIG. 5A wearing eyeglasses 152 mounted on his or her head. Without any movement of user's head i.e. at the canonical position, his/her Field Of View (FOV) is perfectly aligned with virtual object 120 as shown in FIG. 5A and FIG. 5B.

Specifically, as shown in FIG. 5A, user's viewpoint 154 is perfectly aligned with virtual object 120 as shown by optical or alignment axis represented by arrow 164 emanating from viewpoint 154. The result is a perfect centering of his/her FOV with virtual object 120 as shown in FIG. 5B. This represents the canonical position of the system of FIG. 5A-B and of the subsequent related examples. Explained yet another way, in the canonical position represented by FIG. 5A and FIG. 5B, user 202 is directly looking at virtual object/bird 120 resulting in the center of his or her FOV being perfectly aligned with virtual object/bird 120.

As shown in FIG. 5B, environment 200 observed by user 202 comprises several real objects, all denoted by reference numerals 210, and our virtual object or bird 120. As such this situation is representative of an augmented reality (AR) or a mixed reality (MR) system. Once again, though only one such virtual object 120 is shown in these examples, the invention admits of any number of such virtual objects located anywhere within environment 200.

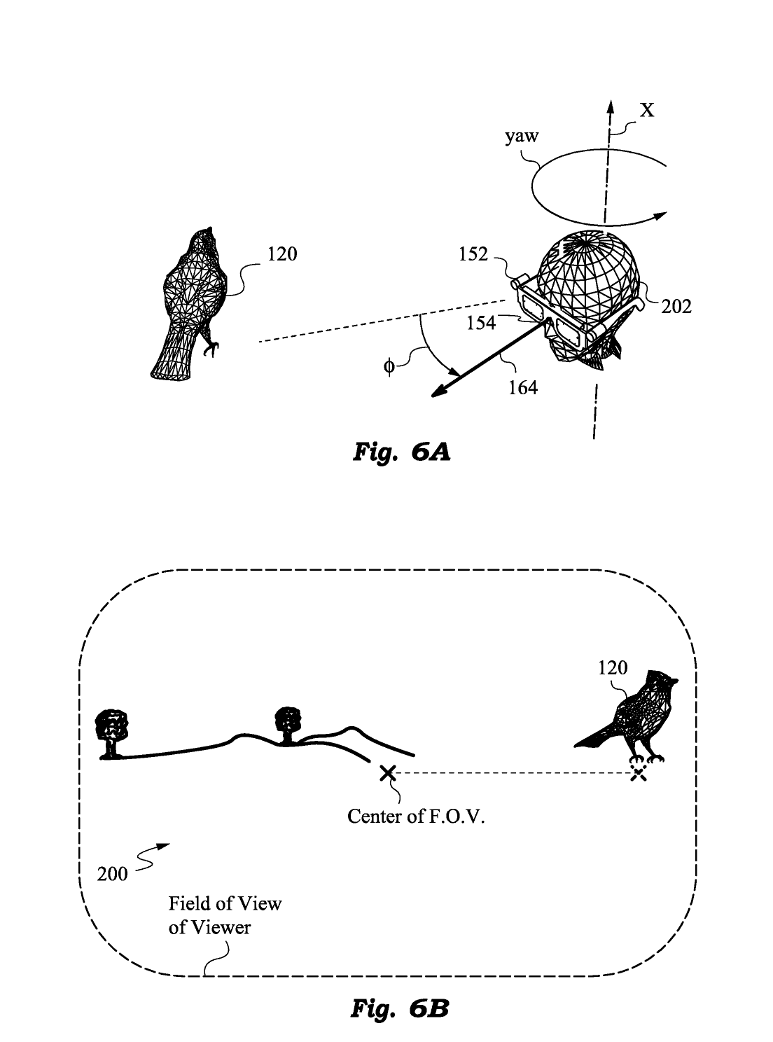

Let us first take the three rotational DOF of user 202 of FIG. 4, along with the camera(s) mounted on eyeglasses 152, and inspect what happens to environment 200 of FIG. 5B as viewed by the user. FIG. 6A shows the situation where user 202 has rotated/Yaw-ed his/her head around X-axis by an angle φ. Prior art applications are unable to determine the new pose of user 202 shown in FIG. 6A on an accurate and timely basis. As a result, the FOV of user 202 remains as shown in FIG. 5B or takes too long to correct, despite the movement of the user's head to the new position of FIG. 6A. The resulting conflict between the human vestibular system and visual systems causes motion sickness or discomfort to user 202 and a degraded VR/AR/MR experience.

That is because of the ‘expectation’ of human brain to see a corresponding correction or change to user's FOV. Such a corrected or expected version of the image of FIG. 5A-B is shown in FIG. 6B. Specifically, FIG. 6B shows that virtual item 120 has moved to the right in the FOV of user 202 in response to his or her rotation composed of just the Yaw shown in FIG. 6A. Such a correction/alteration/adjustment can be made by the projection mechanism in timely manner i.e. while meeting the above taught latency requirements, only if a timely and accurate recovery of the new pose of user 202 in FIG. 6A can be made.

As stated, the above provided references extensively teach the techniques of the recovery of the new pose of user 202. Using those techniques, the present invention is able to immediately correct for the new pose user 202 leading to the corrected/altered projected image of virtual object 120 as shown in FIG. 6B. This results in a smoother, more comfortable, pleasant and immersive VR/AR/MR experience for the user than otherwise possible. Note that reference labels 210 representing real objects in FIG. 5B have been removed from FIG. 6B for clarity.

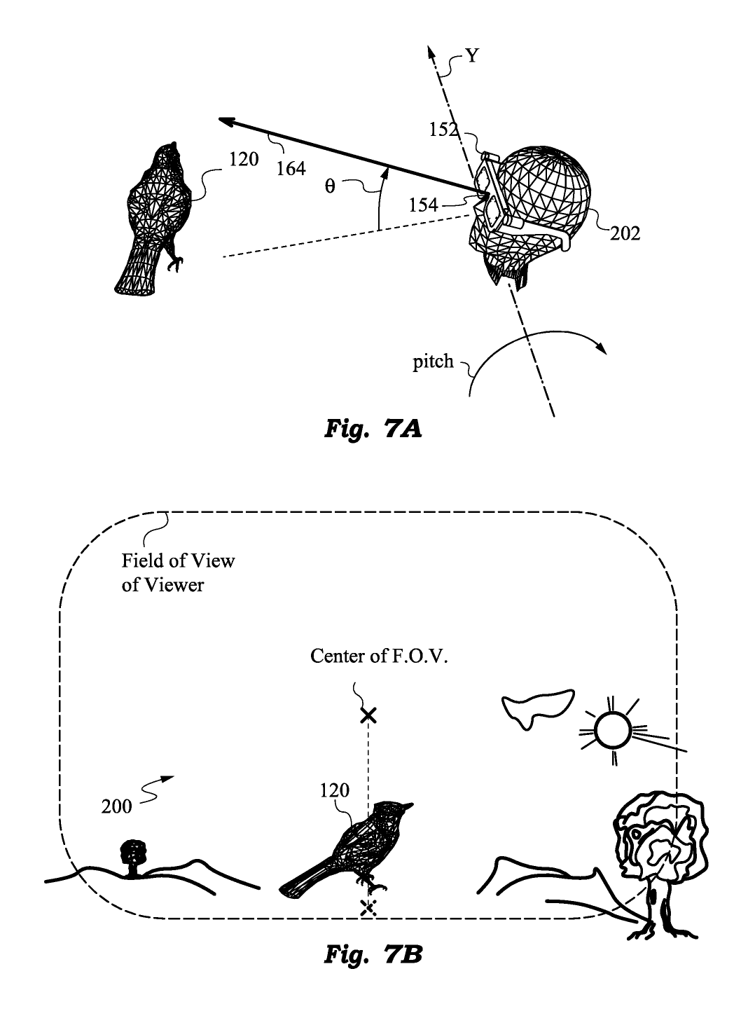

FIG. 7A shows user 202 Pitch-ing his or her head around the Y-axis by an angle of θ from the canonical position shown in FIG. 5A-B. As a result, virtual object 120 should be altered so as to be perceived by user 202 to move towards the bottom of the FOV/screen of the user as shown in FIG. 7B. Without this correction, being applied in a timely manner and enabled by fast and accurate recovery of the new pose of user 202, virtual bird 120 would still be in the center of FOV/screen of user 202 as in FIG. 5B or would take too long to move, thus causing the user motion discomfort/sickness and bringing about the deteriorated VR/AR/MR experience that prevents many users from adopting and benefiting from the full potential of this technology. Note again that reference labels 210 representing real objects in FIG. 5B have been omitted from FIG. 7B for clarity.

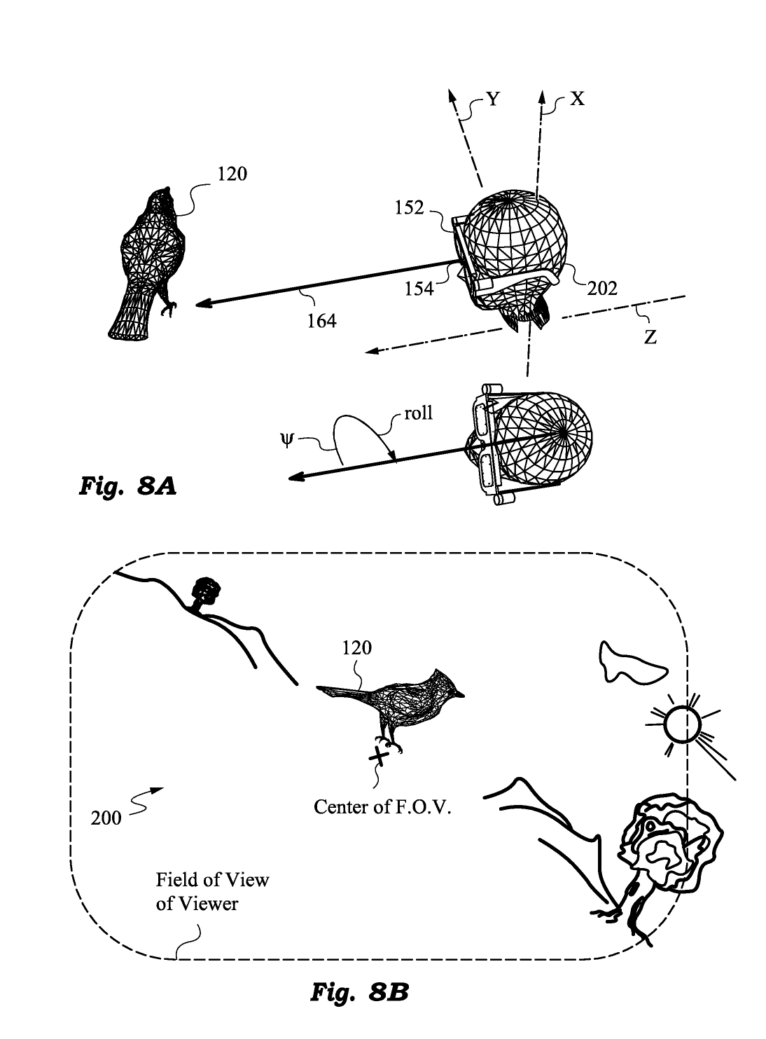

Similarly, FIG. 8A shows user 202 rolling his or her head around Z-axis by an angle of ψ with respect to the canonical position of FIG. 5A-B. This motion should be timely compensated to rotate virtual bird 120 in the Field Of View (FOV) of user 202 as shown in FIG. 8B. In the absence of a timely compensation as is the case in prior art applications, virtual bird 120 would stay put as in FIG. 5B, or take too long to move, causing motion sickness for user 202. As mentioned, the aforementioned alteration of virtual object 120 is achievable by instant invention because it can quickly and accurately recover the new pose of user 202 as his/her head makes any voluntary or involuntary movements during his/her VR/AR/MR experience. Note once again that reference labels 210 representing real objects in FIG. 5B have been removed from FIG. 8B for clarity.

The accurate and timely recovery of pose afforded by the teachings provided in the above mentioned references, allows for requisite image/scene compensation to take place as represented by the above examples. Even if the image/scene compensation is done but not on a timely basis, motion sickness can still occur for the user. Recall the speed/latency requirements between the vestibular and ocular systems as taught above. Appropriate image/scene compensation needs to occur within a certain maximum allowable latency, to avoid conflict between the visual/ocular and vestibular systems of human body that causes motion sickness. Thus if an application is able to produce corrected images of FIG. 6B, 7B and 8B above but it does so after a delay of more than 10 milliseconds, motion sickness for user 202 is still likely to occur especially when object 120 is located in the near-field/range.

The techniques for providing the above corrections by the projection mechanism to images/scenes in the above examples, once the new pose of user 202 is known, are well understood in the art. For techniques regarding fast and accurate pose recovery of the user and related optical apparatuses in a variety of settings, the reader is again referred to U.S. Pat. No. 7,826,641, U.S. Pat. No. 7,961,909, U.S. Pat. No. 8,553,935, U.S. Pat. No. 8,897,494, U.S. Pat. No. 9,235,934, U.S. patent application Ser. No. 14/992,748, U.S. Pat. No. 8,970,709, U.S. Pat. No. 9,189,856 and U.S. patent application Ser. No. 14/926,435.

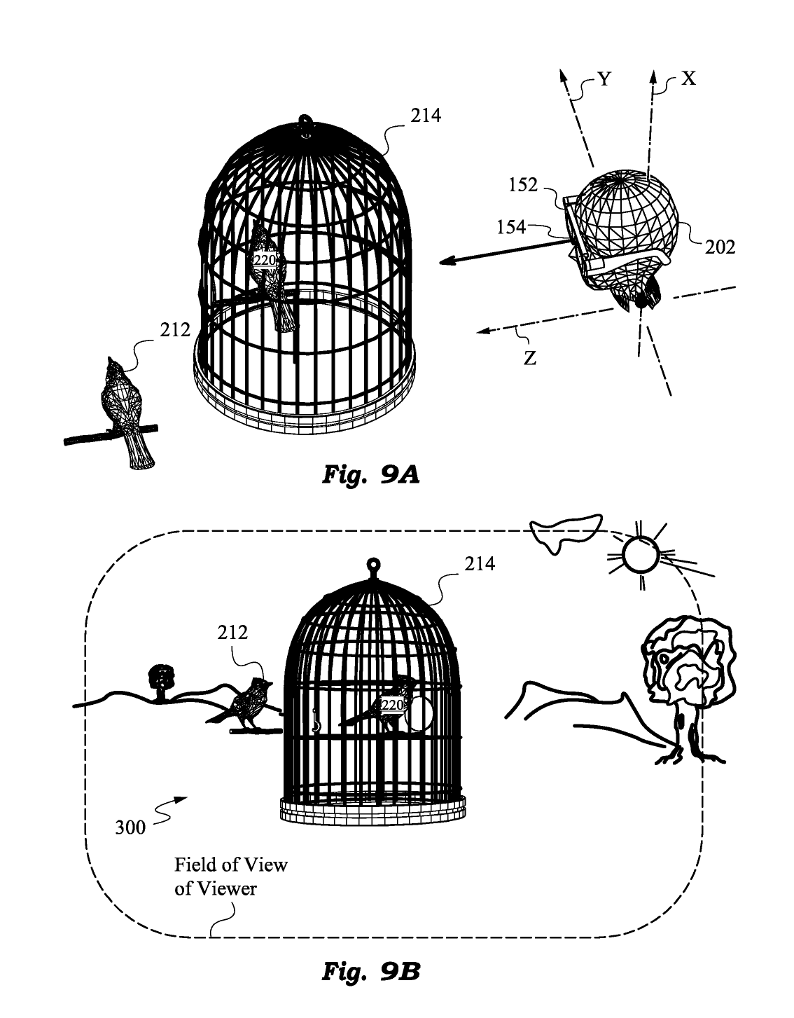

After having reviewed the effects of the three rotational DOF of the camera/user, let us now consider the three translational DOF of the camera/user and the resulting effects on the environments/scenes viewed. For this, consider FIG. 9A that shows a real object 212 which is a bird in the distance, a virtual object 214 which is a cage, and a virtual object 220 which is a bird in cage 214 as viewed by user 202 wearing eye goggles/glasses/visors 152 from a view/vantage point 154. FIG. 9A shows the canonical position of user 202 and glasses 152. The FOV of user 202 at his or her canonical position of FIG. 9A consists of environment 300 as illustrated in FIG. 9B.

Environment 300 is similar to environment 200 of earlier examples including real objects 210 consisting of hills, trees and the sun. However, reference numerals 210 from environment 200 have been omitted in environment 300 for clarity. This allows us to better concentrate on real bird 212 of interest and virtual bird 220 in virtual cage 214, all of which are marked as such in environment 300 of FIG. 9B. To repeat, FIG. 9B represents the scene/reality or environment 300, as viewed by user 202 in the canonical position of FIG. 9A i.e. when the neck of user 202 is at the origin of the shown coordinate system consisting of X-, Y- and Z-axes.

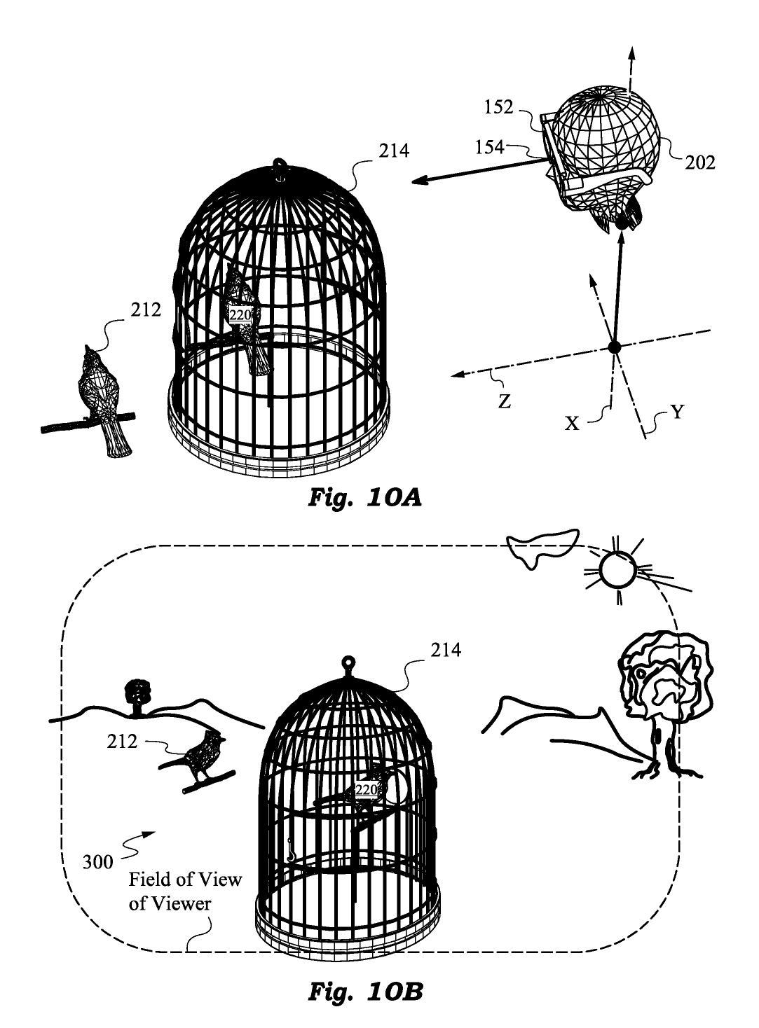

In the canonical position shown, real bird 212 and virtual bird 220 appear to user 202 side by side of each other at about the same height, as shown in FIG. 9B. Now let us examine what happens when user 202 translates his or her head along the X-axis. This is depicted in FIG. 10A. As a result of the translation of user 202 with eyeglasses 152 having onboard inside-out camera(s), environment 300 should be altered as shown in FIG. 10B. Specifically, the FOV of user 202 from view/vantage point 154 is now slightly looking downwards on real bird 212 in the distance and virtual bird 220, with the former slightly higher than the latter.

Without the above correction, real bird 212 and virtual bird 220 (in virtual cage 214) would still be side by side at the same height as in their original positions shown in FIG. 9B or would take too long to correct their positions, causing user 202 motion sickness and a deteriorated VR/AR/MR experience. Timely compensating correction(s) as shown in FIG. 10B are only possible if the new pose of user 202 and glasses 152 can be accurately recovered on a near real-time basis using practical computing resources, as afforded by the teachings provided in the above mentioned references.

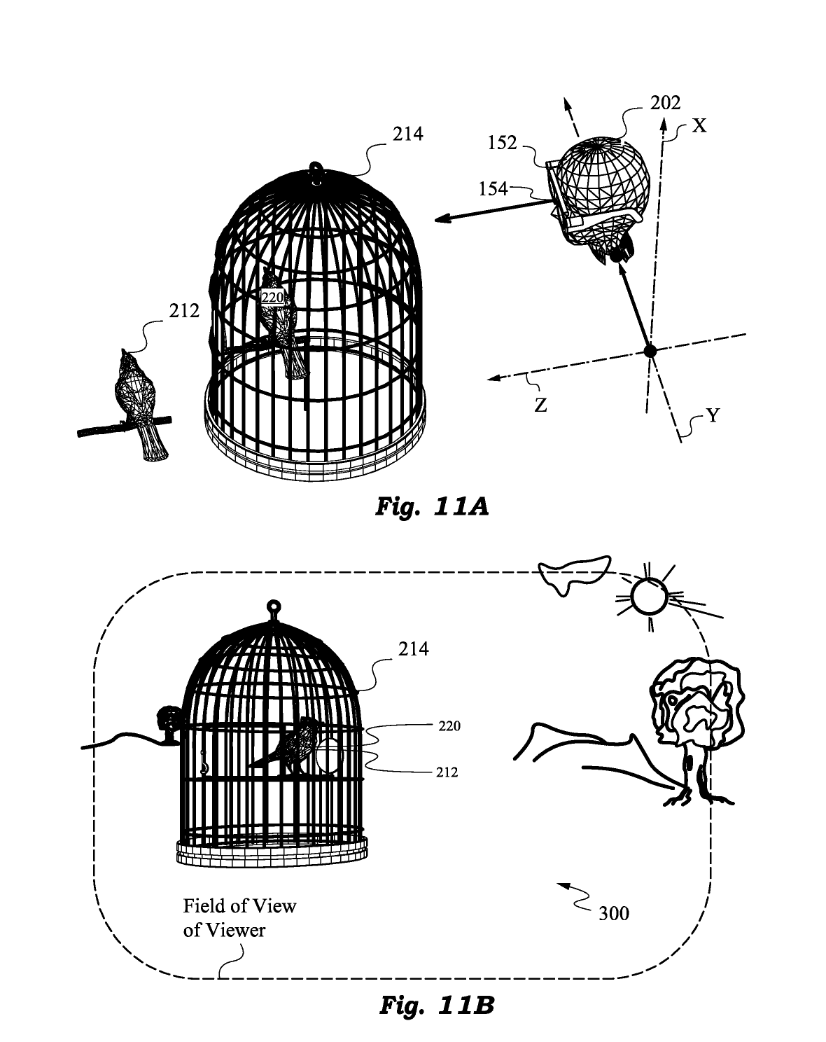

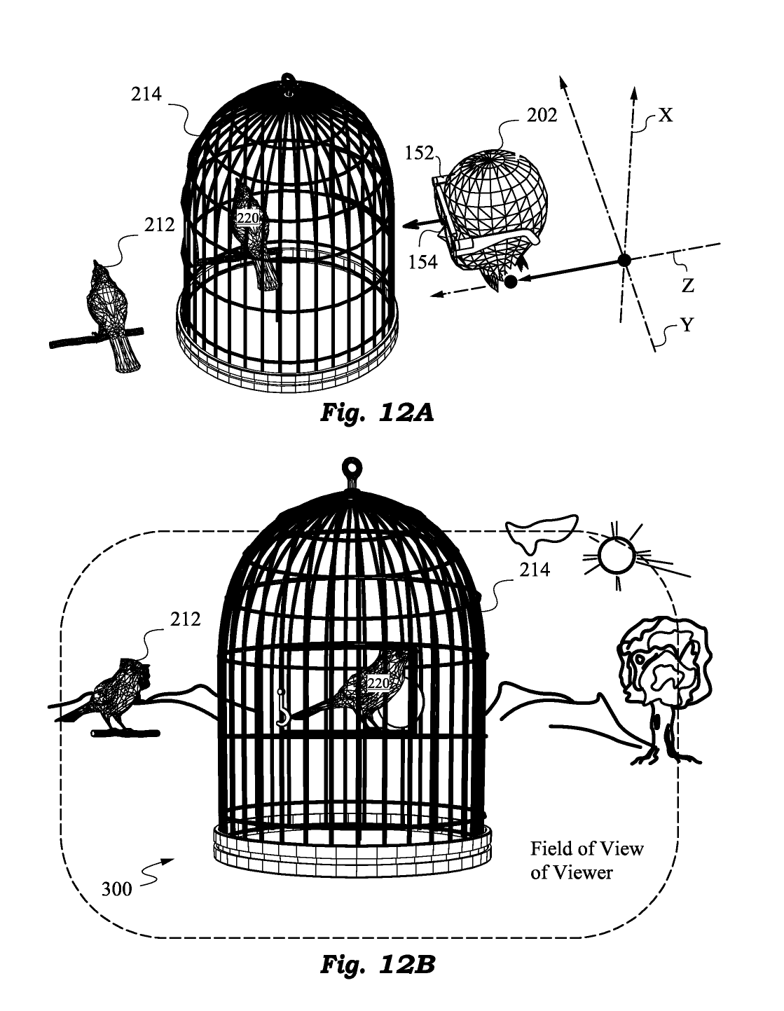

Similarly, FIG. 11A shows a translational movement of user 202 along the Y-axis, requiring correction to environment 300 as shown in FIG. 11B, where the two birds are overlapping each other. In the absence of such correction afforded by a timely recovery of the new pose of user 202 in FIG. 11A, a degraded user experience due to motion sickness is bound to occur. Finally, FIG. 12A shows a translational movement of user 202 along Z-axis requiring a correction to environment 300 where virtual bird 220 and cage 214 appear slightly bigger. In the absence of a timely correction like this, possible due to accurate and timely pose recovery as taught in above mentioned references related to the instant invention, motion sickness and visual discomfort in user 202 is bound to occur.

To summarize, FIG. 10A-B, FIG. 11A-B and FIG. 12A-B illustrate the effect of translational movement of the head of user 202 along X, Y and Z axes and the corresponding corrections to the user's FOV or screen that needs to occur in order to avoid visual/ocular discomfort and/or motion sickness. Specifically, FIG. 10A, 11A, 12A show the translational movements of user 202 along X, Y and Z axes respectively, while FIG. 10B, 11B, 12B represent the corrected/altered position of virtual objects 220 and 214.

In the absence of the above corrections, virtual objects 220 and 214 would stay static as in FIG. 9B which shows the FOV of user 202 in the canonical position. Taking too long to correct, despite the user's translation movements is also not acceptable. As stated, this would cause discomfort for user 202 and a degraded/deteriorated VR/AR/MR experience. Solving this problem is enabled by the instant invention due to the fast and accurate recovery of the new pose of user 202 after the translational movements, allowing corresponding corrections to virtual objects 212, 214 (and any other virtual objects if present) in environment 300 to occur.

Once again, the techniques for providing the above corrections to images/scenes in the above examples, once the new pose of user 202 is known, are well understood in the fields of VR, AR and MR and graphics rendering. As for the techniques relating to fast and accurate pose recovery of user and optical apparatuses in a variety of settings, the reader is again referred to U.S. Pat. No. 7,826,641, U.S. Pat. No. 7,961,909, U.S. Pat. No. 8,553,935, U.S. Pat. No. 8,897,494, U.S. Pat. No. 9,235,934, U.S. patent application Ser. No. 14/992,748, U.S. Pat. No. 8,970,709, U.S. Pat. No. 9,189,856 and U.S. patent application Ser. No. 14/926,435.

As amply taught in the above mentioned references, the movement of a user having an inside-out camera mounted on a wearable such as glasses, along the available 6 DOF can be represented by a collineation or homography. This collineation or homography (often denoted by A or H) is expressed as

$${A}^{T} = \frac{1}{κ} {{R}^{T} ( I - \overline{p} \cdot {\overline{h}}^{T} )}^{T} ,$$

where p̅ is perpendicular to the world surface inducing the homography (with magnitude equal to the inverse of the distance to the surface). R is the complete rotation matrix expressing the rotation of the camera with respect to its canonical position in coordinate system (X,Y,Z), and h̅ is the translation vector of vantage/viewpoint of the camera from its canonical position and the new location at which the new pose is to be recovered.

Note from FIG. 5A that view/vantage point 154 of user 202 moves/rotates with the rotation of the head of user 202 wearing glasses 152. This is because viewpoint 154 is not on any axis of rotation X-, Y-, Z-axes (corresponding to Yaw, Pitch and Roll rotations). The reason for that is that viewpoint 154 is typically located at the center of eyes of user 202, whereas the rotation of the user's head occurs around a pivot point located at the top of the neck or conversely at the bottom of the head. So as the head rotates around X-, Y-, Z-axes, view/vantage point 154 also rotates around those axes, instead of staying stationary.

In other words, there is a linear distance between vantage/viewpoint 154 of user 202 as in FIG. 5A and the actual pivot of the rotation of the neck of user 202 i.e. the distance between the center of his/her eyes and the joints and muscles of his neck where the rotation occurs. Still differently put, the axis of rotation of the head of user 202 is not coaxial with and is below the center of his or her Field Of View (FOV) by the distance between the center of eyes and top of the neck. This offset needs to be accounted for in pose recovery and subsequently for producing appropriate corrections to environment 200 viewed in FIG. 6B, 7B and 8B, rather than presuming viewpoint 154 to be coaxial with the user's center of eyes and at the center of his/her FOV. The techniques of pose recovery taught by the above mentioned related references easily accomplish that.

Specifically, the above offset is accounted for in the translation vector h̅ in the collineation/homography A (or H) presented above and derived in the above mentioned references. Explained further, no matter what the final position of viewpoint 154 of the above examples with respect to its canonical position may be, the resulting collineation or homography incorporates any initial or intervening offsets by determining the final translation vector h̅ where the new pose is recovered. For a detailed treatment of translation and rotation matrices as applied in pose recovery, the reader is again referred to U.S. Pat. No. 7,826,641, U.S. Pat. No. 7,961,909,

U.S. Pat. No. 8,553,935, U.S. Pat. No. 8,897,494, U.S. Pat. No. 9,235,934, U.S. patent application Ser. No. 14/992,748, U.S. Pat. No. 8,970,709, U.S. Pat. No. 9,189,856 and U.S. patent application Ser. No. 14/926,435.

For best stereo vision that can be generated for the user, the inside-out cameras responsible for capturing the scene/environment onto which virtual object(s) are augmented, should be as close to each eye of the user as possible. Referring to FIG. 3A, we see that camera 153A would be close to the retina of left eye and camera 153B would be close to the retina of the right eye of the user, however there is still a “shift” between the retinas and the objective lenses of respective cameras 153A and 153B. This shift, which in many cases is unavoidable, results in environment 142/142′ being produced for left and right eyes, that is slightly different than what the eye actually sees. Therefore, it is advantageous to incorporate the cameras into an optical system, that enables each camera's optical axis to be collinear with the respective ocular axis of each eye of the user. That way this shift can be eliminated, thereby producing a true stereoscopic vision as seen by each eye of the user. This has been accomplished in some systems by using a beam-splitter in the optical path.

Technologies such as virtual retinal display (VRD) or retinal scan display (RSD) or retinal projector (RP) may be useful for the above purpose. However, these technologies still do not address the fact that the cameras are not mounted on the same location as the eye. As will be apparent that for VR, this is not a problem to mount the camera over the eyes because the user does not watch the real scene. But AR is more challenging because one would require mounting the cameras on the same optical axes as the two eyes, and still allow the user to see through unobstructed. Of course, for augmented virtuality (AV) one can design a standard VR headset with the cameras in front of the eyes. Then one would render a combination of the captured video/image/scene and the virtual objects. The user therefore would not directly see the world but a high-fidelity facsimile of it, i.e. the real world translated into the digital space.

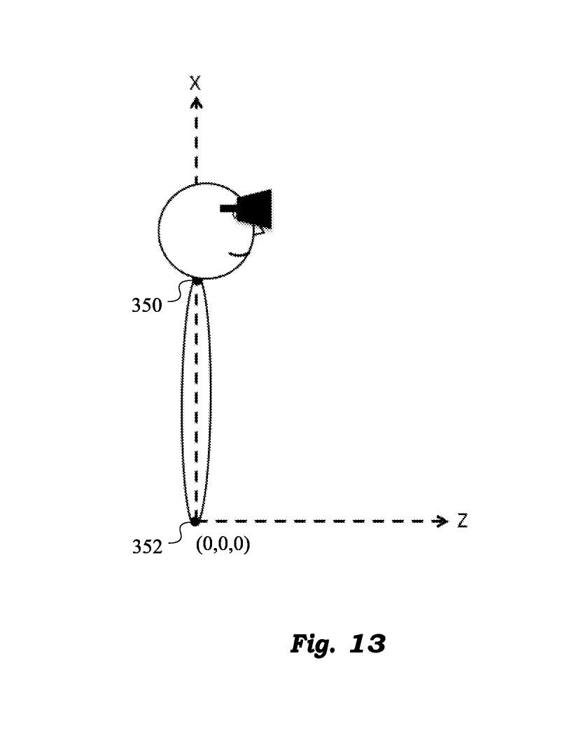

At this juncture, let us study the typical body movements associated with a human user wearing eyeglasses of the previous examples and enjoying a VR/AR/MR experience. The canonical position of such a user is shown in FIG. 13. Note that reference labels for eyeglasses, as well as the user himself/herself have been omitted to avoid detraction in the following explanation. For a human user with head-worn gear such as an HUD or HMD, there are movements of at least two sections of the body that ultimately move the eyes and the HUD/HMD.

One section of the body is the head that pivots around the upper neck as indicated by pivot point 350 in FIG. 13. The other section of the body is the torso that pivots around the lower abdomen as shown by the pivot point 352 in FIG. 13.

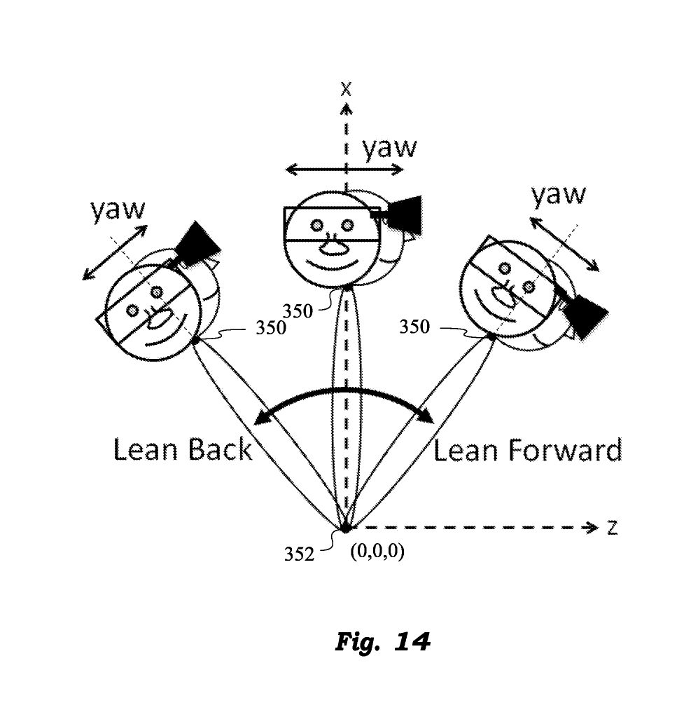

Now, as shown in FIG. 14, a human torso can lean forward or backward around pivot point 352 or around Y-axis. This movement of the user is performed by the abdomen or the lower body. The movement is with respect to the canonical position of FIG. 13, while the user is observing VR/AR/MR scene(s)/environment through the eyeglasses/eyewear or HUD/HMD. The forward or backward movements of torso change the translational position of the user along Z-axis as shown. Furthermore, as the torso moves forward and backward, the height of the user's head with respect to the ground or origin (0,0,0) of (X,Y,Z) coordinate system shown also changes, thereby also translating the user along the X-axis. In addition, the user is also free to rotate his or her neck around the X-axis, i.e. execute a Yaw, as also shown in FIG. 14. This rotation of neck is around pivot point 350 on the upper portion of his/her neck where the head typically rotates.

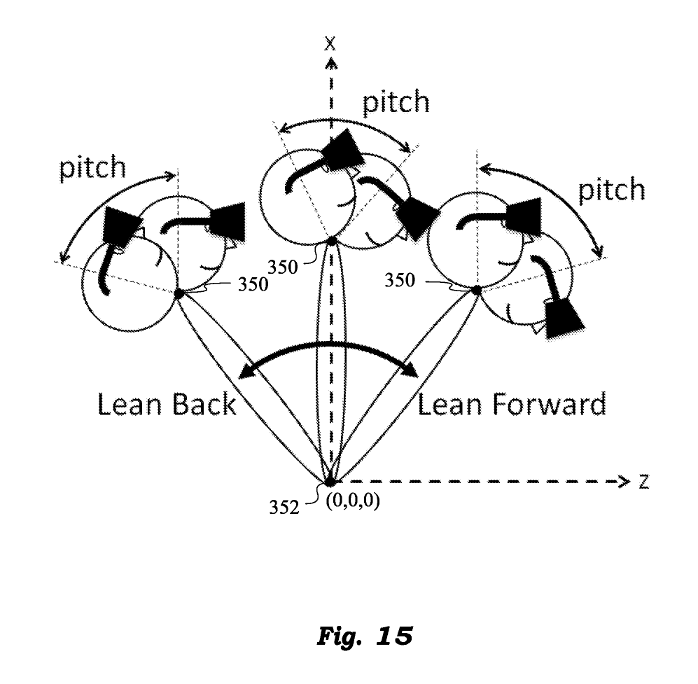

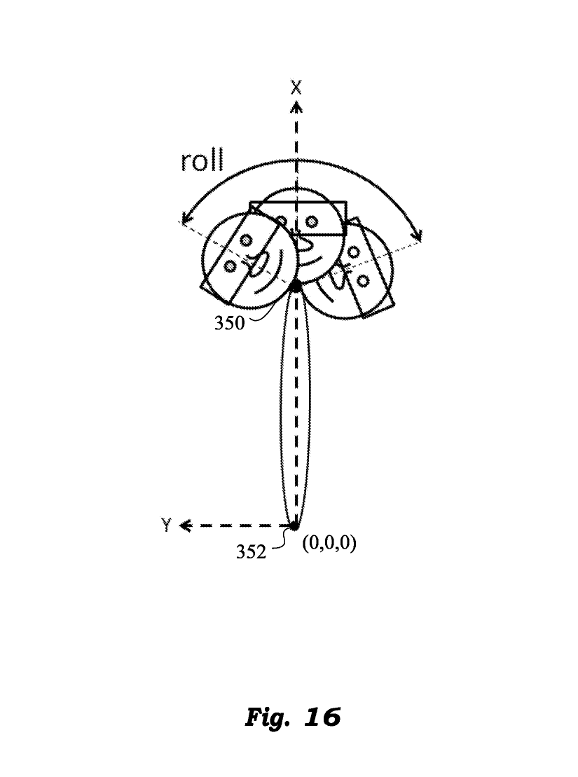

Similarly, as shown in FIG. 15, with the forward and backward movement of the torso of the user around pivot point 352, the user is also free to Pitch his or her neck around pivot point 352 around the Y-axis, which is perpendicular to the page in FIG. 15. Finally, as shown in FIG. 16, with the forward and backward movement of the torso around pivot point 352 with respect to the canonical position of FIG. 13, the user is also free to roll his or her neck around the Z-axis at pivot point 350 as shown. Note that FIG. 16 is a frontal view of the user taken from directly across him or her from the front i.e. along the Z-axis, as opposed to the sideview taken from the side as in FIG. 14 and FIG. 15. As a result, and as obvious, the forward/backward movements of the torso are inside and outside of the page of FIG. 16 (around the Y-axis).

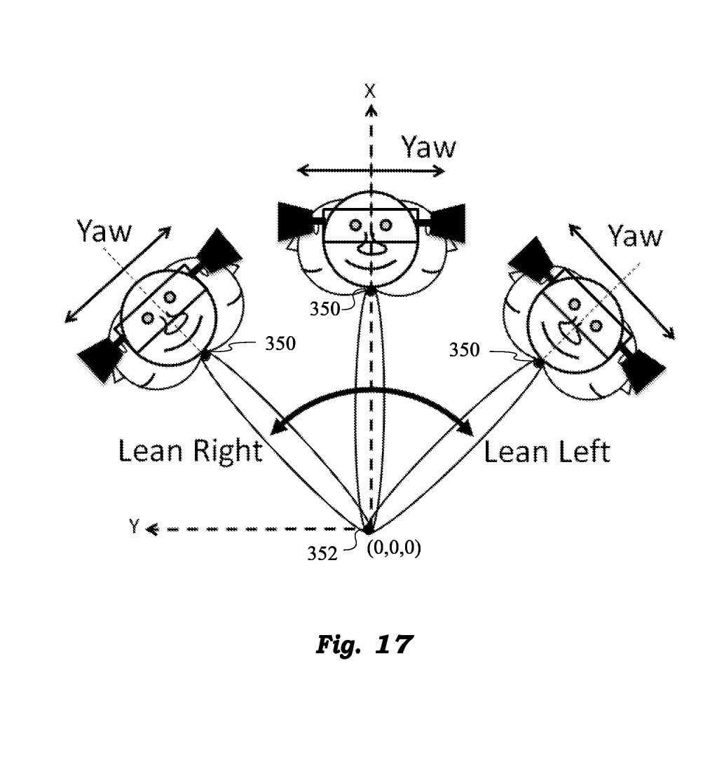

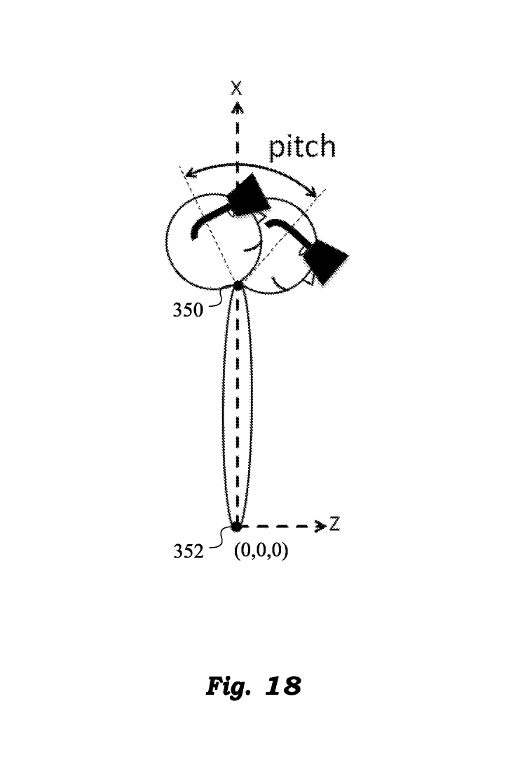

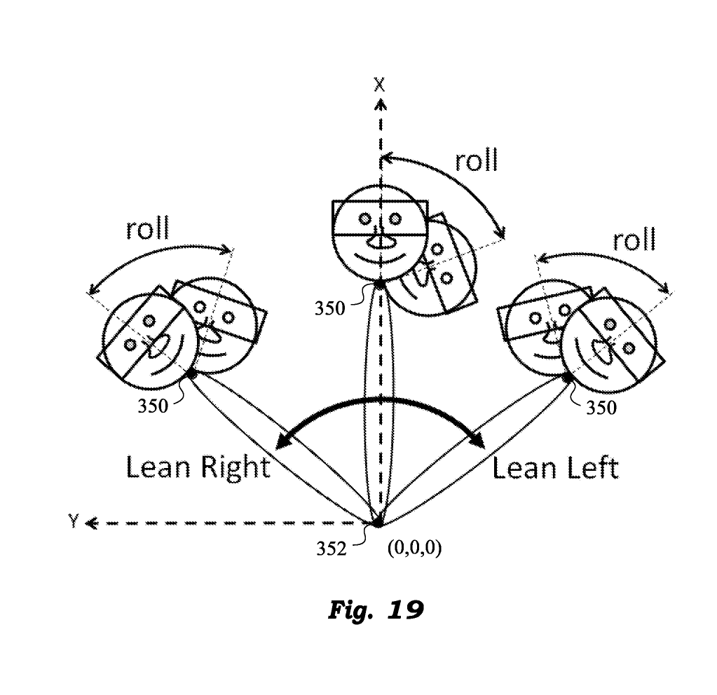

FIG. 17 shows a frontal view of the user from along the Z-axis. FIG. 17 shows the freedom of movement of the user's torso leftward and rightward around pivot 352 or around the Z-axis. This movement is further compounded by the user's Yaw-ing of the neck around the X-axis and pivot point 350. FIG. 18 is a sideview of the user taken along the Y-axis and representing his/her freedom of movement of the neck to Pitch the neck around pivot point 350 or around the Y-axis, in addition to the movement of his/her torso. Of course because of the sideview of the user in FIG. 18, the movement of the torso around pivot point 352 is in and out of the page of FIG. 18 around the Y-axis. Finally, FIG. 19 shows from a frontal view the left and right movement of the torso around pivot 352 or around the Z-axis, compounded by the roll of the neck around pivot 350 (also around the Z-axis).

Regardless of the various movements of the portions of the body of the user as shown in the above examples of FIG. 13-19, the ultimate position of user's eyes or the camera/eyeglasses can be represented as a collineation with a rotation matrix R and a translation vector h̅ with respect to the canonical position of FIG. 13. Again, as amply taught in the aforementioned related patent references, an efficient and accurate recovery of the pose of the user at his/her ultimate position can be easily accomplished using practical computing resources. Based on the recovery of the pose in the new position, the VR/AR/MR scene or environment as viewed by the user via his/her viewing mechanism or optics, can be appropriately generated, altered and/or compensated as desired.

The above alteration/adjustment/modification of the VR/AR/MR scene/image(s) preferably compensates for motion sickness of the user by ensuring that the image seen through the viewing mechanism or viewing optics of his/her wearable such as glasses, conforms the vestibular responses of human brain to the visual system of the body, thereby avoiding motion sickness. As taught above, this typically involves adjusting the image dynamically on a near real-time basis to account for a consistent visual perception by the eyes as observed naturally in the real world. However, there may be other reasons for the above alteration/adjustment of the VR/AR/MR scene/images and changing the viewing experience of the user. These reasons may include specific medical, psychological, mechanical or other needs of the application at hand.

As already stated, pose recovery techniques taught in the above mentioned references allow for a fast and accurate recovery of the pose of the user/camera. A very fast and efficient pose recovery algorithm allows plenty of time for other computing tasks. Many of these (e.g., rendering) are contingent on knowing the pose first. Thus, latency and drift in the image projection system can be reduced as the location and orientation of the virtual object(s) is calculated with time to spare. Note that the image for each eye will be different due to the separation between them. Optometrists call this offset between images perceived by the eyes, the parallax effect due to binocular vision.

It is also important to know where the user is focusing their sight in an AR/MR environment (i.e. close or far away). In general, this is not actively measured but rather inferred or assumed to be in the points/spots of interest. When the user focuses on real and/or virtual objects very far away the parallax effect or problem is simplified. The AR/MR system can then project an orthographic view of the virtual object(s). Such projection works well when the user's eyesight can be thought of “focused at infinity”. Parallax plays no role in such situations and other ocular accommodation issues are minimized. For virtual objects at intermediate distances, human optometry is an issue. It becomes an acute problem when projecting virtual objects in the near field.

Therefore, certain applications use a “window” for looking at AR/MR to side-step the parallax problem. These applications typically use a screen on which AR/MR is projected/displayed. Ideally, the screen is rather large. Still, a smart phone screen may be sufficient under many situations. A big advantage of the window method is that it does not require two separate images of the virtual object normally generated for the left and the right eye separately. Instead, the user looks at the screen and makes the necessary optometric adjustments with their own eyes.

The perception of depth in an AR/MR scene when using the window method does not result from stereoscopic images displayed to the left and right eyes. Instead, depth is inferred/perceived through other means such as textures, shades, shape familiarity, and is built up as the display window is moved around the virtual object(s). This allows the user to see each scene containing the real and virtual objects as they would appear from the various view angles and distances at which the window is placed. In other words, the AR/MR experience is achieved by combining monocular views from the different positions and orientations of the window.

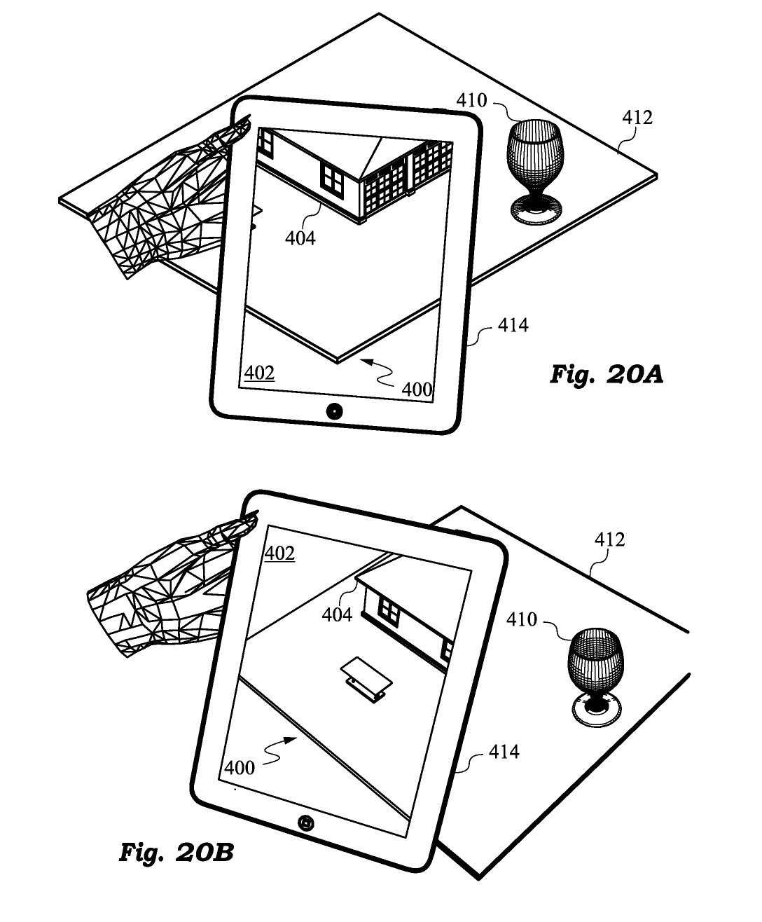

One such application using the above described window method is shown in FIG. 20A-B. FIG. 20A shows an AR/MR environment 400 being viewed on a window/screen 402 of a device or tablet (e.g. an iPad) 414. Environment 400 projected/displayed by a projection mechanism on window/screen or viewing mechanism 402 includes a real object 412 and a virtual object 404. There are other real objects such as wine glass 410 also present that are currently not in the view being projected on viewing mechanism or window 402. The above example embodiment is representative of a “virtual tour” application in real-estate business, where a virtual building 404 is being explored using a device such as tablet 414. FIG. 20B shows that the view displayed/projected on window 402 changes as the user moves device 414 around virtual building 404 to explore it in 3D.

Because the above application uses the window method explained above, only one image/scene 400 needs to be displayed on window 402 without having to be concerned with the stereoscopic vision for left and right eyes typical of HUD/HMD devices as in FIG. 2, FIG. 3A and the associated embodiments. Typically, in such virtual tour applications, the user can also zoom into building 404 by moving tablet 414 inwards or closer to building 404. Such an application is only possible if the changing viewing orientation/angle and position (collectively pose) of tablet 414 along with its inside-out camera(s) (not shown), can be accurately and rapidly determined as the user moves device 414 in and around building 404 to naturally view it as if it were in the real world.

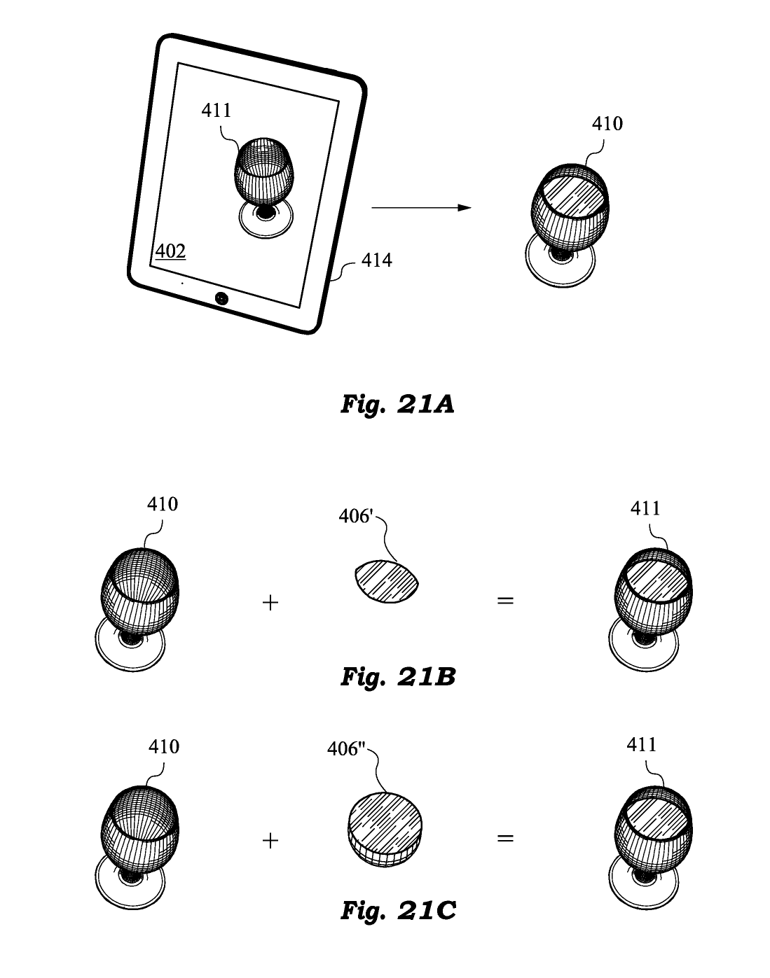

FIG. 21A-C illustrate another example of the window method employed by the instant invention. As shown, FIG. 21A includes a real object 410 which is a wine glass. The objective is to fill our real wine glass 410 with a virtual wine and display the resulting AR/MR full wine glass 411 on screen/window 402 of device 414. There are two ways to accomplish this. One way, depicted in FIG. 21B, does not employ full geometrical modeling of the virtual wine and/or wine glass 410 and simply overlays a virtual wine surface 406′ onto glass 410 to show the resulting AR/MR full wine glass 411 in FIG. 21B. In practice, this can be done with shading or specular effect at the appropriate location in the rendered view. The other method employs a full geometrical model 406″ of the virtual wine, and/or of wine glass 410, and then based on the geometrical model(s) renders a full AR/MR wine glass 411 as shown in FIG. 21C.

Again the above applications are possible if a quick and accurate estimation of the changing pose of device 414 and its inside-out camera(s) (not shown) can be made while the user moves the device around object 410. Such quick and accurate estimations of pose in a variety of settings are thoroughly taught in U.S. Pat. No. 7,826,641, U.S. Pat. No. 7,961,909, U.S. Pat. No. 8,553,935, U.S. Pat. No. 8,897,494, U.S. Pat. No. 9,235,934, U.S. patent application Ser. No. 14/992,748, U.S. Pat. No. 8,970,709, U.S. Pat. No. 9,189,856 and U.S. patent application Ser. No. 14/926,435.

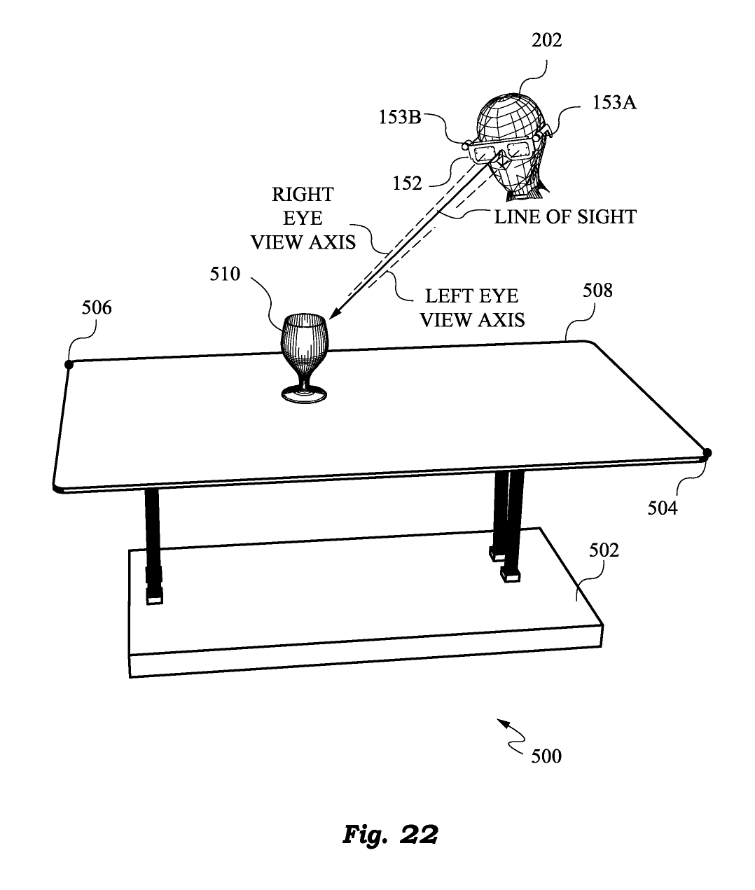

As mentioned earlier, the window method adopted by above and other related embodiments simplifies the projection requirements of the AR/MR scene. It is now enough to project a single scene rather than two different stereo projections, one suited for each eye. This stereoscopic projection required for human binocular vision is especially important for head-worn devices such as HUD/HMD. FIG. 22 shows user 202 wearing eyeglasses/HUD/HMD 152 from the previous embodiments in an environment 500. User 202 is viewing a virtual wine glass 510 on a real table 502.

Table 502 has two reference points 504, 506 and a reference edge 508 that help recovery of pose of user 202 wearing glasses 152 as taught in the above mentioned references. As in previous embodiments, glasses 152 have two inside-out cameras 153A and 153B, although having two (or more) cameras is not a requirement in order to accrue the benefits of the instant invention. In other words, eyeglasses can have only one inside-out camera as well. As shown in FIG. 22, user 202 is viewing virtual wine glass 510 along a line of sight imagined to project from the center between his or her eyes. Further shown in the figure are the two respective imaginary axes of view from user's left and right eyes, specifically from the left and right lenses of glasses 152 of user 202. The left and right axes of user's view converge at wine glass 510 at the point where his line of sight meets virtual object 510.

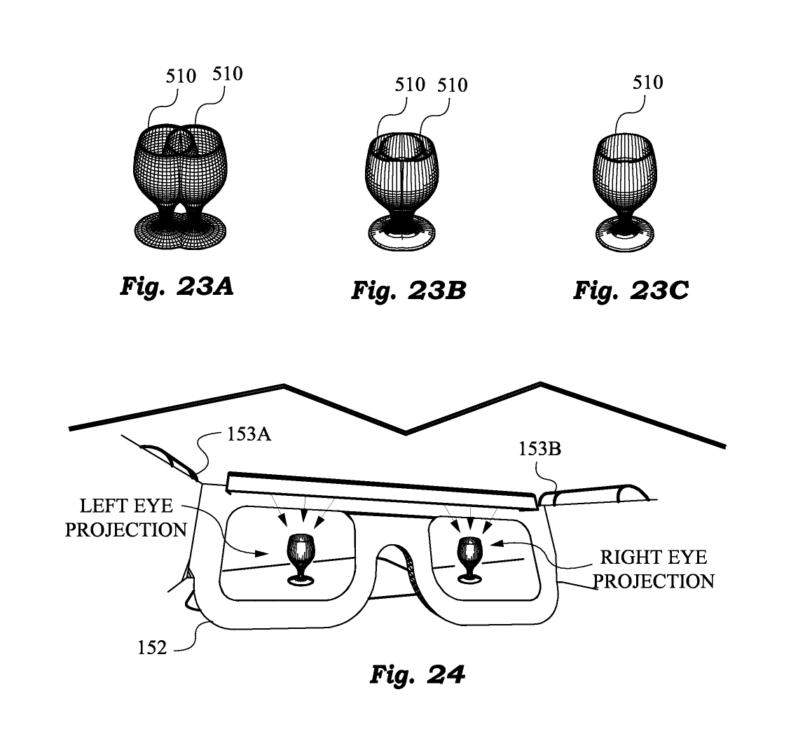

Now let us see what happens in order to resolve the parallax or optometry problem of human binocular vision explained above. For this, let us first see FIG. 24 illustrating the projection of wine glass 510 from FIG. 22 onto the left and right eyes through the respective left and right lenses of eyeglasses/HUD/HMD 152. If the stereoscopic projection or the optometry/parallax problem is addressed extremely poorly or not at all, then user 202 through glasses 152 in FIG. 24 will see two different wine glasses due to parallax. This is depicted in FIG. 23A. If the optometry/parallax problem is solved badly (but better than in FIG. 23A), then the user may see a blurred image consisting of two unresolved wine glasses as shown in FIG. 23B.

Those skilled in the art will understand that vergence is the simultaneous movement in opposite directions of both eyes to obtain or maintain single binocular vision. When the two views corresponding to the two eyes are slightly mismatched as in FIG. 23B, the eyes compensate by adjusting vergence until a single object is perceived. This is the principle behind the stereogram posters that were popular in the 90's. So, for a single object i.e. the glass shown in FIG. 23B, the mismatch simply results in the glass being perceived at a slightly farther (or nearer) location than it should. However, when there are more than one virtual objects present, then the mismatch cannot be solved with a global vergence adjustment, or when the adjustment contradicts real objects present. The user then strains to perceive the scene. In such a case, perceived objects alternate between sharply or ghostly appearances.

Finally, if the optometry/parallax problem is addressed correctly, then the user would see a realistic and natural image for a distinct virtual wine glass 510 as shown in FIG. 23C at the right place. It is no surprise, that since solving the stereoscopic vision or optometry/parallax problem in practical applications generally requires complete mathematical modeling of objects and may be non-trivial to achieve on a near real-time basis, some applications “cheat” and side-step this problem. They typically do this by restricting the dynamic depth range of the scene, and/or mostly projecting the virtual objects in the foreground (ahead of the real objects in the scene), or projecting them in the background at infinity. In any case, a correct and speedy recovery of user/camera pose is necessary to provide a realistic projection of the environment being viewed. For techniques on efficient recovery of pose in a variety of situations, the reader is again referred to above mentioned references.

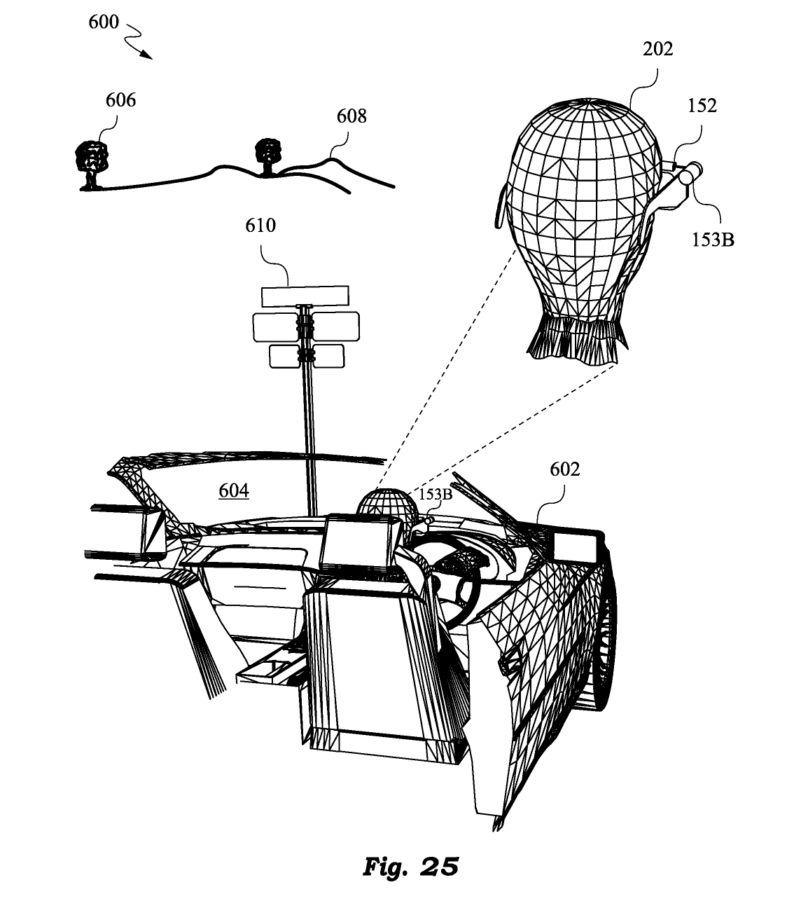

FIG. 25 shows another AR/MR environment 600 comprising user 202 wearing head-gear 152 and driving a car 602. As before, head-gear/HUD/HMD 152 has two inside-out cameras, of which only right side camera 153B is visible in FIG. 25. Of course, the invention admits of requiring only one (or more) cameras to accrue its benefits. User 202 is viewing environment 600 through and on windscreen 604. Environment 600 comprises real objects 606, 608 and others not referenced by specific reference numerals for clarity.

Furthermore, environment 600 viewed by user 202 through and on windscreen 604 also has one or more virtual objects. One such virtual object 610 is shown, which is a road-sign. In addition to virtual object 610 there may be a virtual tachometer or other gauge or readings projected on windshield 604 of car 602 by the projection mechanism involved (not shown) of the application. Such projection mechanism may include appropriate hardware and software technologies available in the art for rendering images on windscreen 604. Alternatively, or in addition, the whole or part of the dashboard of car 602 may be virtual.

In the above embodiment, it is very useful if virtual road sign 610 or other virtual objects as desired e.g. various dashboard gauges, moved on windscreen 604 according to the movement of user's head. That way, the important safety and driving information is always available to the driver in his/her view, wherever on windscreen 604 he/she may be focusing. This is even more important for pilots who would like their flight data to be displayed onto the windscreen/windshield in concert with the movement of their head.

Of course, the above is easily accomplished by a timely and accurate recovery of the pose of user's eyes/head, utilizing the inside-out cameras of eyewear 152. Based on the changing pose, the position of the virtual object(s) can be changed on the viewing mechanism such as windscreen 604 of FIG. 25, to stay in the field of view of the user/driver/pilot. In some cases, it may be convenient to park the virtual object(s) that are very important for the user to see at the periphery of the field of view no matter what the user does. The above application is another example of the window method introduced earlier, where the window is windscreen 604 and/or virtual dashboard.

In a close variation of the above embodiment, the projection mechanism does not physically display/project the AR/MR scenes onto windscreen 604 but rather the AR/MR images are projected only onto the lenses/optics of eyeglasses 152 worn by user 202. In other words, the user views windscreen 604 through the viewing optics of his/her eyeglasses onto which the projection mechanism projects virtual road sign 610. Obviously, the user further sees real objects 606, 608 (and others if present) through the same viewing optics onto which virtual object 610 (and any other virtual objects if present) are projected. It is also conceivable to have a combination of the above two variations.

In any case, as in prior embodiments, in order to provide a pleasant/comfortable and useful projection of environment 600 whether onto eyeglasses 152 or onto windscreen 604, the pose of user's head or glasses 152 with cameras 153A-B must be known. Based on that pose, as elaborated in the above examples, the appropriate alterations/corrections to virtual object 610 and other virtual objects if present, can be made.

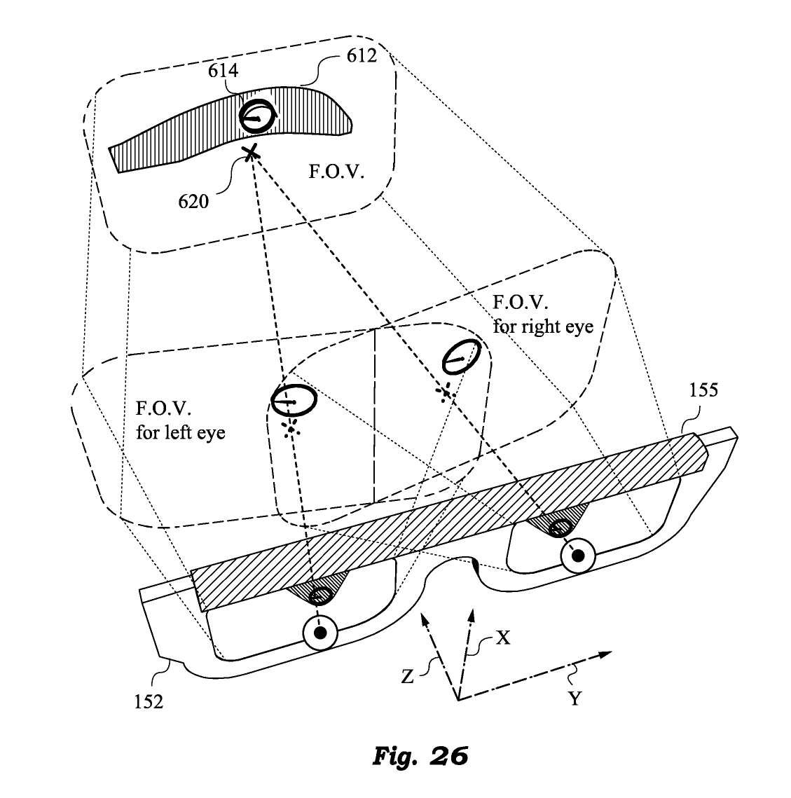

One such image/scene adjustment or correction can be the resolution of the optometry or the parallax problem. For the automotive embodiments of FIG. 25 let us further turn to FIG. 26 to understand the parallax problem. FIG. 26 shows our AR/MR glasses 152 with left and right viewing optics/lenses as shown. Note in FIG. 26, projection mechanism 155 responsible for displaying or projecting images/scenes onto left and right lenses/optics of glasses 152 is explicitly shown and labeled. As already noted before, in various embodiments taught herein, the projection mechanism may be attached to or operably connected to or affixed to or integrated with the viewing mechanism of the system. Exemplary viewing mechanisms are the viewing optics/lenses of eyeglasses 152, and windscreen 604 in the present embodiments.

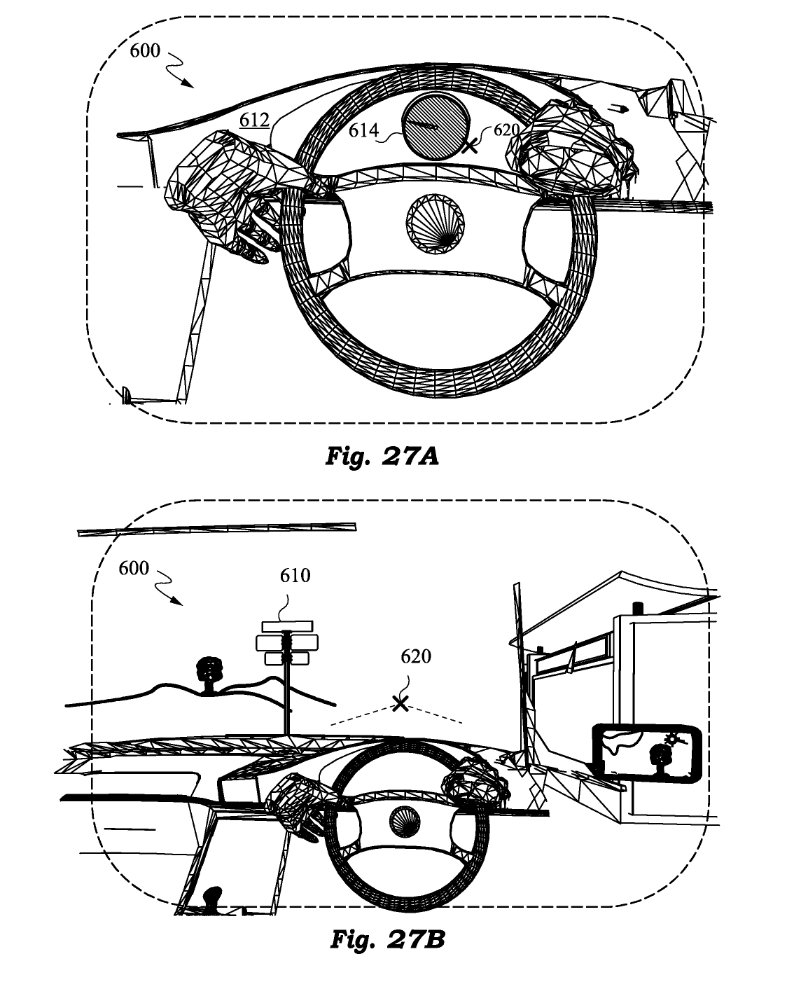

FIG. 26 further shows a virtual dashboard 612 with a virtual tachometer 614 projected onto the viewing optics of glasses 152. As shown in FIG. 26, the field of view (FOV) of the left eye in near-field is disjoint from FOV of the right eye. At this distance in the near-field, the parallax problem needs to be properly addressed. However, as the distance from glasses 152 to the point of focus 620 of the eyes increases, the two FOV's converge, and the parallax problem is minimized. To further explain, these two situations are explicitly depicted in FIG. 27A and FIG. 27B respectively.

Specifically, in FIG. 27A the point of focus 620 of user's eyes is on the dashboard which is in the near-field. At this distance, the parallax/optometry problem is significant and must be properly addressed in order to provide a realistic and pleasant/comfortable AR/MR experience to user/driver 202. However, as shown in FIG. 27B, when point of focus 620 of driver's eyes is at infinity (recall vanishing points from projective geometry), the parallax problem may not need to be fully resolved in order to read the distant virtual road-sign 610 without discomfort. Once again, the parallax problem for the above automotive embodiment can be properly addressed on a near real-time basis by an accurate and efficient recovery of the pose of user/driver 202 as taught in the above mentioned references.

According to the present invention, the appearance of one or more virtual objects displayed/projected on a viewing optics or mechanism is altered or modified according to a property (or properties) of an inside-out camera utilized by the system. Preferably, the property is the pose (position and orientation, also sometimes referred to as the extrinsic parameters) of the camera. The inside-out camera is utilized to capture the reference objects (points, edges, etc.) in the environment, based on which the pose of the camera is estimated, as per the above references. Preferably still, the property is a homography induced by some surface in the real scene. The homography implicitly conveys the pose of the camera.

Recall that in an AR/MR system, the scene/images captured by the inside-out camera are overlayed by one or more virtual objects. In a pure VR environment, the entire scene created for the user and displayed on the viewing optics/mechanism is virtual. In this case, the user is transposed to a reality that is artificial and synthesized. This is achieved by blocking the user's view of the surroundings with closed goggles/glasses/visors that also serve as displays for images rendered by a computer. The user feels immersed or ‘present’ in the synthesized reality if the rendered virtual scene reacts to the user's actions in the same manner the eye view of a natural scene would do.

Therefore, in a highly advantageous embodiment, the above alteration/modification of one or more virtual objects is done so as to reinforce this sense of “presence” of the user in the VR environment. This reinforcement of the presence of the user manipulates the scene(s)/object(s) viewed by the user and their reactions to user actions and movements, so as to make them appear and feel as desired to enhance the sense of presence. One requirement for such manipulation could be to make the VR scene/object(s) appear and react to user's motion as naturally as possible compared to how they would appear and react if they were real.

In an AR/MR environment, user's view of the natural environment is not blocked but rather captured by a camera and then ‘augmented’ by the layering one or more virtual objects on/in it. This is typically achieved by a see-through display of some type, be it goggles, contact-lenses, car windshields, or display windows/screens. A computer renders the image of one or more virtual objects in such a way that the user believes that the object(s) (rather than the user himself/herself as in the case of VR) are part of the actual surroundings. The virtual item(s) feel “present” if the rendered images for the user react to the user's actions in the same manner as natural item(s) would.

Therefore, in another advantageous set of embodiments, the above alteration/modification of one or more virtual objects is done so as to reinforce this sense of presence of the object(s) in the AR/MR environment. This reinforcement of the presence of the item(s) or virtual object(s) involves manipulating them to react to user actions and movements, such that they appear and feel as natural objects to the user. The manipulation of item(s)/object(s) may also be to satisfy any other requirement specific to the application at hand for reinforcing the sense of presence of the item(s).

Of course a critical aspect of the reinforcement of the sense of presence, whether it be that of the user in a VR, or of one or more objects in AR/MR, is the knowledge of the pose of the user and/or the camera. Based on the changing pose of the user/camera, the objects in the VR/AR/MR can be manipulated to appear as they would naturally to the eyes.

In still other related embodiments, the above alteration/modification of the one or more virtual objects is done so as to apply a certain texture or color to the virtual object(s). This could be used in AR/MR applications where a red color or prickly texture can be overlaid on top of an object in response to the user getting too close to the object(s) (or the object(s) suddenly becoming dangerous). Similarly, a virtual obstruction can be used to cue the user to avoid an area or path in an AR/MR application.

Now let us understand the technical mechanisms typically involved in the manipulation of the virtual objects rendered for the user in the above embodiments. As already stated, the rendering is done by a projection mechanism that typically renders the scene/object(s) on some viewing mechanism/optics. Such viewing mechanism/optics may involve viewing lenses of eyewear, or display windows/screen of an electronic device (e.g. a tablet). Those skilled in the art will understand that in 3D computer graphics, the rendering pipeline or graphics pipeline refers to the sequence of steps/stages that are required to create a 2D raster representation of a 3D scene/image.

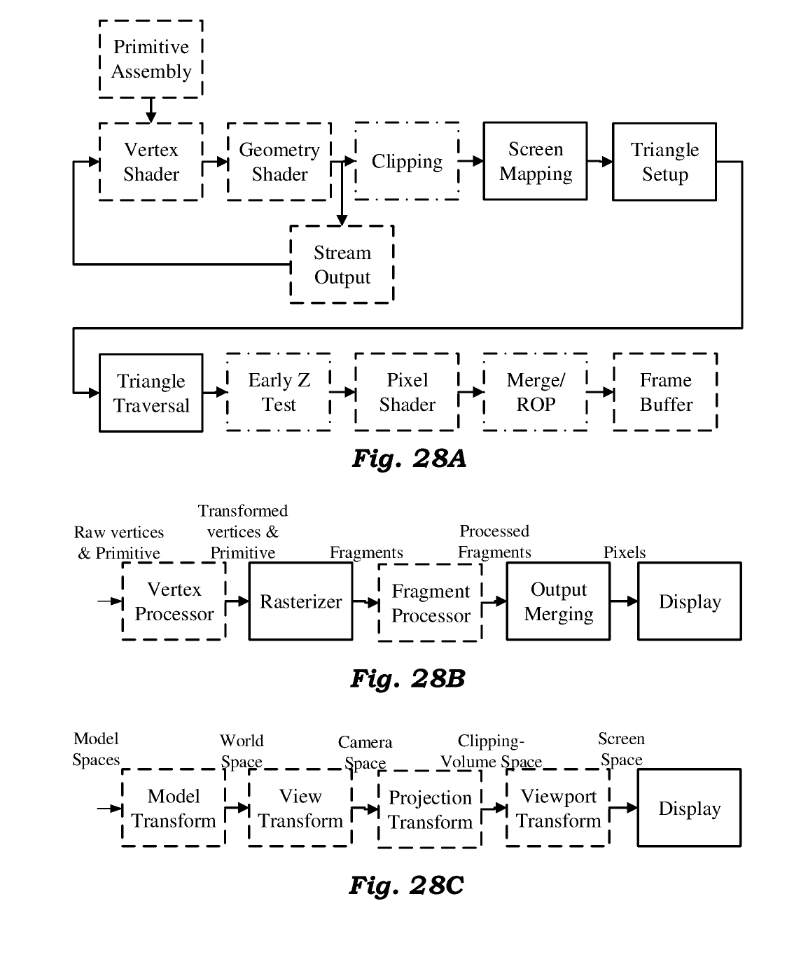

Once a 3D model of an object has been created, the graphics pipeline is the process of rendering that 3D model onto a display. The following few paragraphs in relation to FIG. 28A-C describe the basic operations involved in executing the graphics rendering pipeline. These will be well understood by a reader of average skill and are provided for completeness. For a thorough treatment of this subject, the reader may refer to J. Gregory, Game Engine Architecture, A. K. Peters Ltd., 2009, and the myriad of other reference literature available in 3D graphics books and on the web.

FIG. 28A shows the generic implementation of a graphics pipeline, extensively described in Chapter 10 of J. Gregory, Game Engine Architecture, A.K. Peters Ltd., 2009. Boxes with solid lines are fixed-function, those with dot-and-dashed lines are configurable and those with dashed lines are programmable. The Open Graphics Library (OpenGL) specification provides a simplified implementation of the above rendering pipeline, as represented in FIG. 28B, where the same convention of FIG. 28A for showing programmable, configurable and fixed-function boxes is used.

Output of one stage/step is fed as input to the next stage. A vertex has attributes such as position in (x, y, z) coordinates, color (RGB or RGBA), vertex-normal (nₓ, n_{y}, n_{z}) and texture. A primitive is made up of one or more vertices. The rasterizer raster-scans each primitive to produce a set of grid-aligned fragments, by interpolating the vertices. Vertex processing shown in FIG. 28B, takes geometry data (e.g., a list of points) describing a graphics primitive and applies a series of transformations. Typically, the rendering pipeline involves four types of transformations: model, view, camera and viewport transformations as shown in FIG. 28C.

Model, view and camera transformations are done at the vertex processing stage. Model transformation refers to the arrangement of objects within the synthesized scene or world. The view transformation refers to the position and orientation of the view that is to be presented to the user. Camera transformation refers to the (virtual) lens parameters through which the scene is to be visualized. All these transformations are programmable as shown in FIG. 28C, which uses the same convention for showing fixed-function, programmable and configurable boxes/processes as in FIG. 28A-B.

Continuing further in FIG. 28B, fragment processing first performs rasterization: each graphic primitive is converted to a set of grid-aligned fragments enclosed within the primitive. At this point viewport transformation (see also FIG. 28C) is done. In other words, viewport transformation is done during rasterization, and refers to the size, shape and location of the display area to map the projected scene. This transformation is also programmable as shown in FIG. 28C.

After rasterization, fragment processing also performs texturing of each fragment, lighting and fog effects, fragment culling tests (such as scissor test, alpha test, stencil test and depth buffer test), and finally pixel-based operations (such as blending, dithering, logical operations and bit-masking). All these operations are either programmable or configurable.

After the above primer on 3D graphics rendering pipeline, let us now turn our attention to the relevant embodiments of the invention. A person skilled in the art can readily see that the appearance of one or more virtual objects in the above embodiments, can be changed in numerous ways given the versatility of the graphics rendering pipeline. Therefore, in another set of highly advantageous embodiments, the alteration/modification of the one or more virtual items in the above embodiments, entails changing one or more configurable or programmable parameters of a graphics rendering pipeline.

The configurable and programmable parameters of a graphics rendering pipeline have already been introduced above and are associated with configurable and programmable functions/boxes shown in FIG. 28A-C. For a detailed overview of these parameters, the reader is again referred to any of the many available texts on 3D graphics. At the minimum, they include vertex operations, fragment operations and pixel-based operations. Thus not only can the coordinates of the virtual item (i.e. the model transform) may be altered based on one or more properties of the inside-out camera, but any configurable or programmable parameter in the rendering pipeline may also be altered. Furthermore, these parameters may also include shading, diffusion and light-scattering effects applied to the image fragments of the virtual object(s) being altered.

As already taught above, the alteration of one or more virtual objects is done based on one or more properties of the inside-out camera of the system. One such property can be a pose of the camera. This use-case makes it highly applicable to VR/AR/MR environments. However, many other properties utilizing the inside-out camera can be used. These properties can be recovered, reconstructed or measured from the output of the inside-out camera. A non-exhaustive list includes: parallax, image sharpness, lens distortion, image blur or defocus, vignetting, lens flare, brightness, image texture, image disparity, z-depth, optical flow, image noise or grain, lighting and shading, edge and corners, SiFT features, foreground silhouettes, occlusions, vanishing points, foci of expansion, motion blur and spatiotemporal intensity fluctuations.

We have already explained parallax above and provided several examples of how the projected image/scene may be altered to resolve the parallax or optometry problem (see. FIG. 22, FIG. 23A-C, FIG. 25, FIG. 26, FIG. 27A-B and the associated explanation).

Preferably, the property based on which the one or more virtual objects are altered, is image sharpness. In other words, based on the desired or required level of image sharpness of the output of the camera, the one or more virtual objects are altered accordingly. Preferably, the property is lens distortion. This embodiment may involve a defect in the lens of the inside-out camera that results in an image distortion of the AR/MR scene being viewed. This distortion is then compensated for virtually using graphics rendering techniques provided above so a corrected image/scene can be presented to the user.

In the present embodiment, lens distortion can also be a desirable effect to enhance the sense of space or vastness. In such case, the appearance of a virtual object can be appropriately distorted as a result of changing the camera viewpoint. In a variation of this embodiment, a drop in image sharpness may be the result of fog or haze in the real scene. The sharpness of the virtual object can then be similarly reduced to match the perceived physical reality.

Preferably, the above mentioned property of the inside-out camera is an image blur or defocus that needs to be corrected/compensated for. Alternatively, this property may be used to have the appearance of the virtual object appropriately match the blur or defocus conditions. Several examples of this were provided above in relation to resolving the optometry or parallax problem. In addition, the image blur or defocusing may happen due to any number of other reasons, including the optical properties of the lens(es). In any case, these may be corrected for the user by employing the techniques provided herein.

Preferably, the above mentioned property of the inside-out camera based on which one or more virtual objects are altered, is vignetting. In photography and optics, vignetting is a technique for drawing attention to the center by reducing the image's brightness or saturation at the periphery compared to the image center. Therefore, based on the vignetting required for our VR/AR/MR scene, the virtual object(s) may be altered as desired. For example, if a virtual object is at the periphery of the scene it may be intentionally dimmed to draw more attention to the center.

Preferably, the above mentioned property of the inside-out camera is lens flare. Lens flare is the light scattered in the system through usually (unwanted) image formation mechanisms. These can be internal reflection and scattering from inhomogeneities in the lens material. However, a lens flare may be used deliberately to invoke a sense of drama. It may also be added to an artificial or augmented image to give it a sense of realism—implying that the image is an un-edited original image of a real-life scene. Therefore, in this embodiment, lens flare may be used as the basis for the alteration/modification of the one or more virtual object(s) in the VR/AR/MR scene. Reasons for doing this alteration may be to reduce the effects of unwanted lens flare, or to deliberately enhance the effect of lens flare for dramatic or real-life effects.

Preferably, the above mentioned property of the inside-out camera is brightness. Depending on the brightness level of the scene captured by the inside-out camera, a variety of appropriate alterations to the virtual object(s) may be warranted. For example, if the image is bright, brighten the virtual object(s) also, and vice versa.

Preferably, the above mentioned property of the inside-out camera is image texture. As understood in the art, an image texture is a set of metrics in image processing for quantifying the perceived texture of an image. Image texture provides information about the spatial arrangement of color or intensities in an image or selected region of the image. Thus based on the texture of the image/scene of the inside-out camera, appropriate alterations to the virtual object(s) may be warranted. One example would include retexturing the virtual object according to the texture of the rest of the image. One could texture the virtual object to match or contrast with the rest of the scene/image.

Preferably, the above mentioned property of the inside-out camera is binocular disparity, which refers to the difference in image location of an object seen by the left and right eyes, resulting from the eyes' horizontal separation (parallax). It is used by the brain to extract depth information from the two-dimensional retinal images in stereopsis. Therefore, objects or images may be virtually manipulated to produce the desired level of binocular disparity. As would be obvious from above, one reason for doing that may be to provide stereo vision for the user.

Preferably, the above mentioned property of the inside-out camera is z-depth. A common use of this property is for depth keying, which consists of grouping pixels based on their relative distance to the background. Thus, this property can be employed in a number of ways to alter the virtual images of our VR/AR/MR scene. The virtual object (or parts of the virtual object) can be rendered translucent over pixels with a low key (i.e., further into the background), or opaque over pixels with a high key (i.e., closer to the foreground).

Preferably, the above mentioned property of the inside-out camera is optical flow which is the pattern of apparent motion of objects, surfaces and edges in a visual scene, caused by the relative motion between an observer and the scene. The observer can be a person or a camera. As an example, a VR/AR/MR scene in the present embodiment may be manipulated to provide an illusion of movement.

Preferably, the above mentioned property of the inside-out camera is image noise. Image noise can take many forms, and is random variation of brightness or color in images. Usually it is an aspect of electronic noise or the ‘graininess’ of the film. Image noise is an undesirable by-product of image capture that adds spurious and extraneous information. Hence an example use-case would be to virtually manipulate the VR/AR/MR scene to counter image noise, or in an alternative scenario to enhance the noise for any reasons.

Preferably, the above mentioned property of the inside-out camera is shading (or conversely lighting). Shading means depicting depth perception in 3D models or illustrations by varying the levels of darkness/shading. Thus in the present embodiment, the VR/AR/MR scene may be altered based on the shading/lighting requirements of the scene. An example could use applying color/media to the image more densely or darkly for areas that should be perceived to be dark, and applying the colors/media lightly to areas that should be perceived to be lighter.

Preferably, the above mentioned property of the inside-out camera is one or more edges in the VR/AR/MR scene. Based on the edges any type and number of manipulations/alterations to the scene/objects may be desired. In a similar embodiment, the above mentioned property of the inside-out camera is one or more corners in the VR/AR/MR scene. Based on the corners any type and number of manipulations/alterations to the scene/objects may be desired. Examples of these include varying the details of the scene/objects in order to conform, align or to contrast with the edges and corners of existing objects in the scene.

Preferably, the above mentioned property of the inside-out camera is Scale-invariant Feature Transform (SiFT or SIFT) features. SIFT is an algorithm of computer vision to detect and describe local features in images. Thus in the present embodiment, a VR/AR/MR scene may be manipulate/altered according to the features extracted by SIFT. Examples of such manipulation/alteration include varying the contrast of the scene/objects according to high-contrast edges and corners detected by SIFT. Since SIFT is useful in image recognition, there are numerous possibilities of using computer vision to study the VR/AR/MR scene thusly manipulated in the present embodiment based on SIFT features.

Preferably, the above mentioned property of the inside-out camera is foreground silhouettes. Thus in this embodiment, VR/AR/MR scene may be manipulated to accentuate, highlight or annotate the silhouettes of one or more objects in the scene. Examples of this manipulation include increasing the lighting of objects surrounding the silhouetted object or darkening the silhouetted object compared to the surroundings.

Preferably, the above mentioned property of the inside-out camera is vanishing points. Recall from perspective geometry that a vanishing point is a point in the picture plane that is the intersection of the projections of a set of parallel lines in space on to the picture plane. The classic example is the point where railway tracks appear to intersect in the distance in a picture viewed from the front. Thus in the present embodiment, depending on the vanishing points present in the VR/AR/MR scene, certain manipulation/alterations of the scene/objects may be warranted. Examples of such manipulations include scaling the object according to how far/close those vanishing points need to be.

Preferably, the above mentioned property of the inside-out camera is foci of expansion. When the camera/observer is moving forward, the corresponding optical flow contains a focus of expansion. It is a point from where the objects in the image appear to be expanding. A classic example is when the camera is moving inwards towards a point in the scene, the objects around it expand or become bigger and appear closer and then eventually disappear out of bounds at the periphery. The center or the point around which this expansion occurs is the focus of expansion. It is the point towards which the camera is moving inwards in the above example.

Thus in this embodiment, depending on one or more of such foci of expansions in the scene based on the camera movement, virtual objects/images in the VR/AR/MR scene may be altered or manipulated. Examples of such manipulations/alterations include enlarging or expanding the objects around the focus of expansion so that the movement appears real-world and realistic.

Preferably, the above mentioned property of the inside-out camera is motion blur, which is the apparent streaking of rapidly moving objects in a still image or in a sequence of images. It occurs when the image being projected or recorded changes during a single exposure, either due to rapid movement of objects and/or extended length of the exposure. Thus in this embodiment the virtual/augment/mixed scenes or objects are manipulated according to the presence/absence of the motion blur. For example, the manipulation may involve blurring the virtual object(s) in the scene so they appear to match the amount of motion blur of other real objects in the scene. Still in another example, the virtual object(s) may be blurred so as to create a perception of the movement of the objects.

Preferably, the above mentioned property of the inside-out camera is spatiotemporal intensity fluctuations. In this embodiment, the manipulation or alteration of virtual object(s) may be warranted due to the intensity changes in space and time. An example scenario includes changing the light intensity of the virtual object(s) to account for changes in light intensity on other objects in space and time.

As will be evident, the above examples offer a vast number of possibilities for the property (or properties) of inside-out camera based on which image alteration of a VR/AR/MR scene is performed according to the invention. Furthermore, the alteration or manipulation of the scene could be simple or complex. Preferably, the alteration is merely a change in the position of one or more virtual objects. Among the many possible choices for the reasons for such alteration include improving stereoscopic vision, reinforcing the sense of presence for the user and/or the object(s), or providing a more comfortable/pleasant and natural experience to the user.

Preferably, the alteration is consonant to a movement of the user. Among the many possible choices for the reasons for such alteration include reducing motion sickness for the user by keeping the projected image/scene consonant with the voluntary or involuntary movements of the user. Under such circumstances it is advantageous for the movements of the user to be constrained. Such constraint on the motion of the user/camera results in a reduced homography associated with the changing pose of the user/camera.

A reduced homography is preferably possible because of the presence of structural uncertainties in the optics of the viewing mechanism, or because of structural redundancies caused by the conditioned motion of the viewer. The reduced homography employs a reduced representation that is much more efficient to compute for estimating the user/camera pose, than regular homography. For a detailed treatment on pose recovery using homography, the reader is referred to U.S. Pat. No. 8,970,709, U.S. Pat. No. 9,189,856 and U.S. patent application Ser. No. 14/926,435.

In an interesting embodiment of the invention there are two users of the system. First user views the projected/displayed VR/AR/MR scene as before, while the second user is associated with the inside-out camera. Preferably the second user carries or wears the inside-out camera. This way the scene that is being projected and altered for the first user is actually from the perspective of the second user. An example use-case for such an application is a video game where the user plays a game (or otherwise uses the system) from the perspective of the second user. Note here that although the above explanation uses a first user in the singular, there could be any number of such users present that view the projected/displayed VR/AR/MR scene from the perspective of the second user/avatar.

In alternative embodiments, there is only one real user (or set of real users), while the virtual object is an avatar of a second user thereby giving the illusion of the presence of a second user. The virtual user or avatar is then manipulated according to the one or more properties of the inside-out camera per above teachings. The inside-out camera is preferably mounted on the first user. In a variation, the virtual object could also be a tool or an implement which is altered or manipulated based on the pose of the inside-out camera.

The viewing optics or mechanism may preferably be integrated with the inside-out camera. This would be typical of a set of VR/AR/MR eyeglasses or goggles or visors where the left and right optics through which the user views or sees the environment are the same respective left and right optics which are used by the inside-out camera/cameras as its/their lenses. Alternatively, the viewing optics or mechanism may just be affixed to the inside-out camera. Examples of such a setup include eyeglasses 152 of FIG. 3A, and subsequent embodiments with their associated figures and explanation. In other related embodiments, the viewing mechanism or optics may be connected to the camera, or still alternatively, may just be attached to it. The skilled reader will realize the many design choices available for utilizing the inside-out camera and the viewing mechanism/optics within the scope of the invention.

As already described, the viewing optics or viewing mechanism may employ a display unit such as a screen/window. Devices such as a smartphone, a tablet as well as HUD/HMD/eyeglasses 150 of earlier embodiments would be examples of that. Preferably the projection mechanism used to project/display the VR/AR/MR scenes/objects is integrated with the display unit. This would be typical of a smartphone or tablet, although many other possibilities exist. For example, retinal projections onto the user's eyes would utilize the natural lenses inside user's eyes as the viewing optics through which he/she views the environment and onto which the alteration to the virtual object(s) occurs. Alternatively, viewing optics may be just attached, connected or affixed to the display unit.

As extensively taught in the above embodiments, the viewing optics may be replicated/duplicated for producing a stereo vision for the user. Recall the discussion around the stereoscopy, optometry or the parallax problem. In fact, the viewing optics may take many other forms, e.g. a telescope, binoculars, etc. In other words, the user may view a VR/AR/MR environment through the optics of a telescope that has a projection mechanism for projecting/displaying virtual object(s) on its optics. Same principle applies to binoculars.

In another set of highly advantageous embodiments, the system utilizes a control device or a controller for controlling the one or more virtual objects in the VR/AR/MR scene. Preferably, the controller is a wearable device. Preferably the controller is used to control the alterations/modifications to the virtual object(s) in the scene. Examples of such a control device or controller include a joystick, a game controller (e.g. Nintendo Wii), a touch sensor (e.g. Apple Magic Trackpad, Lenovo K5923 Multi-gesture Touchpad), a gesture sensor (e.g. the ones used in games and smartphones), a digital pen (e.g. a stylus), a proximity sensor (e.g. a capacitive, photoelectric or inductive sensor), a vicinity sensor (e.g. a sensor using radio frequency identification (RFID) technology), an electromagnetic sensor, an inertial sensor (e.g. an accelerometer or a vibration sensor) or one of the many types of motion sensors.

In similar embodiments, instead of a control device, the system simply uses an auxiliary sensor for controlling the appearance/modification of the one or more virtual objects. Preferably, the auxiliary sensor is an optical sensor, an inertial sensor (e.g. a gyroscopic sensor, or an accelerometer), a magnetometer, an optical flow sensor, a displacement sensor, an acoustic sensor, a Radio Frequency (RF) sensor. All the above sensors and sensor technologies are well understood in the art and they will not be delved further into this specification.

There are many interesting applications conceivable for using a control device or an auxiliary sensor in the above embodiments for the alteration/modification of the one or more virtual objects/items. Examples include game controllers, e.g. joystick or other types of input devices for effecting alterations to the appearance of the virtual object(s). Other examples include instrumenting the gamer with the auxiliary sensor so that his/her actions, such as movements or gestures or sounds, may be tracked/measured by the sensor and adjustments made to the one or more virtual objects accordingly.

In an interesting variation of the above embodiments, the user of a device views the VR/AR/MR scene from a device viewpoint (instead of a user viewpoint as in earlier embodiments). As before, a projection mechanism is employed to alter the appearance of one or more virtual images/objects in the VR/AR/MR scene as seen by the user from the device viewpoint. There are many interesting use cases for such a scenario.

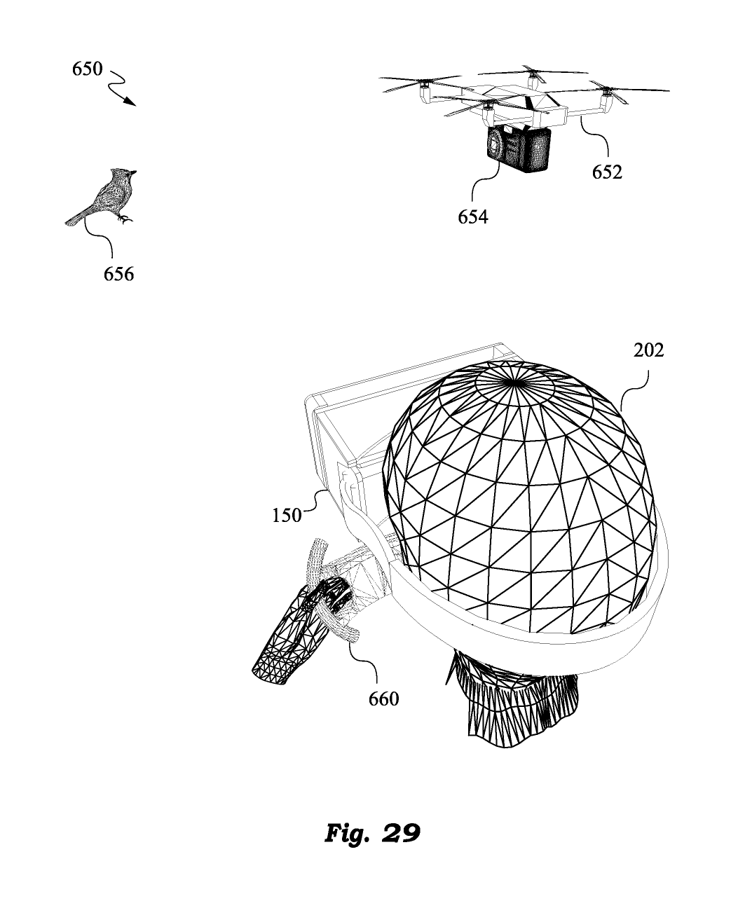

One such use case is illustrated in FIG. 29 showing user 202 wearing HUD/HMD 150 from our earlier embodiments. Although HUD/HMD or headset 150 presumably incorporates a handset (e.g. a smartphone, see also FIG. 2), the embodiment is agnostic to the type of technology and is equally capable of working with fully integrated eyeglasses/goggles 152 taught earlier, or any other type of device having appropriate projection and viewing mechanisms.

In the embodiment shown in FIG. 29, user 202 views a VR/AR/MR environment 650 from the viewpoint of a device 652 which is a drone. Drone 652 has an inside-out camera 654 and it is from the viewpoint of this camera that user 202 sees environment 650.

Alternatively, inside-out camera(s) can be separately mounted on, affixed to or in some other way operably connected to device 652. Furthermore, as before, there can be one or more inside-out camera(s) on device 652 providing either monocular, binocular/stereoscopic or other types of vision of environment 650 to user 202. Environment 650 contains a virtual object 656 and potentially other virtual and real objects which are not explicitly shown in FIG. 29 to avoid detraction from the principles of this embodiment.

Obviously the important difference in the present embodiments is that instead of viewing the environment from the viewpoint of the user himself or herself, the environment as projected/displayed by the projection mechanism is viewed from the viewpoint of a device. This detachment of the viewpoint and associated viewing optics/mechanism from the user himself/herself provides a lot of interesting applications. One such application is shown in FIG. 29, where user 202 is controlling drone 652 with a controller 660.

However, many other applications of the present embodiments are possible. For example, the device can be a robot controlled by a control mechanism such as a computer software/hardware or by the user himself/herself either manually or through an electronic control mechanism. The device can be an instrument or an implement or a tool controlled by the user, typically from some distance. Still possibly, the device may be any remotely controlled automotive equipment, such as a car, train, truck, etc. Alternatively, device 652 may be autonomous, or semi-autonomous with little or no control over it exercised by user 202.

In alternative variations, a light-field camera (such as a Lytro camera or a Pelican camera) can be used to collect composite optical information and permit rendering from many vantage points within a certain volume. A light-field camera is advantageous for pose recovery using the techniques of the above provided references, because it captures intensity as well as the direction of the light emanating from the reference points in the environment. A light-field camera is typically more resource intensive than a conventional camera in terms of power and computation requirements. Hence, appropriate resources need to be made available to the camera, whether it is placed on a drone/device or otherwise made available to the viewer, such as in an HUD/HMD.

As used in the present variations, a device in general may fall into two broad categories. It is either an implement/tool operated by the user either directly (e.g., by hand) or autonomously, or the device is a wearable device, which is carried or worn by the user. In the former category of manipulated devices/items, the device may be attached to a mechanical linkage having up to six degrees of freedom that allow total freedom of motion or a constrained freedom of motion. The device may further be wireless or attached by a flexible tether (with or without stress relief of torque relief).

The category of implements/tools generally includes wands, flying drones, remotely controlled cameras, portable phones, portable electronic devices, medical implements, digitizers, hand-held tools, gaming controls, gaming items, digital inking devices, pointers, remote touch devices, TV remotes and magic wands. In terms of use-cases, the manipulated device/item is a portable phone that is used to control a user device which is a game console, a television, a stereo, an electronic picture frame, a computer, a tablet, an RF transmitter unit, a set-top box, a base station, a portable user device having a display, a non-portable user device having a display, an appliance or the like.

The category of wearable devices/items generally includes items affixed on headgear, on glasses, on gloves, on rings, on watches, on articles of clothing, on accessories, on jewelry, on accoutrements and the like. Any of such wearable devices can be used to control a user device that is a game console, a television, a stereo, an electronic picture frame, a computer, a tablet, an RF transmitter unit, a set-top box, a base station, a portable user device having a display, a non-portable user device having a display, an appliance or the like.

All other teachings of the earlier embodiments including where the VR/AR/MR environment was seen from a user viewpoint, also apply to the present embodiments where the VR/AR/MR environment is viewed from a device viewpoint. For example, one or more virtual objects/images layered on the environment by the projection mechanism, as seen by the user from the device viewpoint can be altered or manipulated based on one or more properties of the inside-out camera(s) as taught earlier. The myriad of choices of such properties have already been taught above. Similarly, the many choices for the type of viewing optics/mechanisms, wearables, etc. have also been taught above. Furthermore, as before, projection mechanism may include a display screen unit or screen/window and the associated teachings of earlier embodiments apply. Still further, the various types of alterations/modifications to the scene and the motivations behind them as taught above, also apply to the present embodiments.

Preferably, the alteration/modification of the one or more virtual objects/images/scene is consonant to a movement of the device—notice the contrast to the earlier embodiments where the alteration was consonant to a movement of the user. However, again among the many possible choices for the reasons for such alteration include reducing motion sickness for the user by keeping the projected image/scene consonant with the voluntary or involuntary movements of the device. Under such circumstances it is advantageous for the movements of the device to be constrained. Such constraint on the motion of the camera results in reduced homography associated with the changing pose of the device/camera.

The reduced homography employs a reduced representation that is much more efficient to compute for estimating the device/camera pose, than regular homography. For a detailed treatment on pose recovery using homography, the reader is referred to U.S. Pat. No. 8,970,709, U.S. Pat. No. 9,189,856 and U.S. patent application Ser. No. 14/926,435.

In another set of embodiments of the instant invention an optical sensor is used for imaging space points of a reality that is viewed by a viewer. The space points would preferably be non-collinear. The optical sensor may be an inside-out camera as taught earlier. Again, there may be multiple optical sensors employed for producing stereoscopic vision for the viewer, or for other reasons pertinent to the application. Then a mechanism is used to generate one or more virtual objects/items that are layered on the reality viewed by the viewer. Such a mechanism can employ graphics rendering pipeline capabilities and embody the projection mechanism of earlier examples. Then, utilizing the optical sensor(s), the system tracks the movement of the viewer and the above mechanism modifies the one or more virtual objects/items on the reality according to that tracking.

As taught earlier, one reason for tracking the movement of the viewer may be to improve his/her viewing experience, such as, by reducing the motion sickness associated with his/her voluntary/involuntary movements. Still other reasons may include changing his viewing experience according to specific medical, psychological, mechanical or other needs of the application. The optical sensor(s) of this embodiment may be worn in a HUD/HMD or other gear of the earlier embodiments.

The modification of the one or more virtual items may also be according to one or more properties of the optical sensor. Accordingly, the types of properties of the inside-out camera taught earlier, and the teachings of the prior embodiments apply to the present variation(s) employing optical sensor(s) also. In another embodiment, the inside-out camera is attached to an autonomous, or semi-autonomous device, and the scene is displayed to a sentient being (e.g. human). In this embodiment, the scene is displayed and updated with virtual objects for the human but from the viewpoint of the autonomous or semi-autonomous device (e.g. robot, drone, etc.).

In another set of highly interesting embodiments, an immersive sports experience may be provided for the user. In such embodiments, the user with HUD/HMD wearables or some other appropriate viewing and projection mechanisms, that may be the same as or similar to earlier embodiments or entirely different designs, may be virtually transported into a sports event. The sports event or game may be a Soccer, NFL, MLB, NBA, NHL, etc. game, and the user may be able to interact with the virtual objects present in the VR/AR/MR scene/game.

The experience in above embodiments could be an AR/MR or VR experience as taught earlier. The virtual objects may be completely fictitious or a rendition of actual objects and/or players of an actual game/team. It is easy to extend these embodiments to fantasy team, and further to completely fictitious objects related to sports or otherwise, that one may be able to interact/play with in the VR/AR/MR embodiments afforded by the instant invention. Indeed, many other applications are conceivable according to the teachings and within the scope of the invention.

The methods of the invention further provide the steps required to layer one or more virtual objects/items onto a VR/AR/MR scene. The scene is viewed by a viewer from a viewer viewpoint using a viewing optics/mechanism. The viewer can be a machine such as a robot, a manipulated/controlled tool or implement, or an artificial agent. Alternatively, the viewer can be a sentient being such as a human, or an animal. The layering is performed by a projection mechanism that is capable of displaying the scene to the viewer using any number of mechanisms available in the art.

The methods further provide that the appearance of the one or more virtual objects/images in the scene viewed by the viewer may be altered based on one or more properties of an inside-out camera. Teachings of the earlier embodiments, including the types of properties of the inside-out camera, the choices of how the inside-out camera may be connected to capture the real environment, the types and choices of projection mechanism, viewing optics, types and choices of alterations/modifications to the scene, etc. still apply.

The methods provide that the alteration of the one or more virtual objects/images/scene is preferably consonant to the motion of the viewer. As taught earlier, a constraint on such a motion results in homography that only requires a reduced representation and is more efficient to compute than a full homography requiring a regular/full representation. Such a reduced and computationally efficient representation for the homography is possible due to structural uncertainty present in the viewing optics/mechanism.

In addition, the reduced representation of the homography may also be possible due to structural redundancy caused by the conditioned motion of the viewer. For a full treatment of reduced homography and pose recovery in the presence of structural uncertainty and structural redundancy, and the associated topics, the reader is referred to U.S. Pat. No. 8,970,709, U.S. Pat. No. 9,189,856, U.S. patent application Ser. No. 14/926,435.

It will be evident to a person skilled in the art that the present invention admits of various other embodiments. Therefore, its scope should be judged by the claims and their legal equivalents.

1. A system comprising:
(a) a viewing mechanism employed by a user for viewing a virtual item from a user viewpoint;
(b) a projection mechanism for altering an appearance of said virtual item from said user viewpoint based on a property of an inside-out camera.

2. The system of claim 1, wherein said virtual item is a part of a scene, and said scene is selected from the group consisting of a virtual reality scene, an augmented reality scene and a mixed reality scene.

3. The system of claim 1, wherein said property is selected from the group consisting of a pose and a homography.

4. The system of claim 1, wherein said property is selected from the group consisting of a parallax, an image sharpness, a lens distortion, an image blur, a vignetting, a lens flare, a brightness, an image texture, a binocular disparity, a z-depth, an optical flow, an image noise, a shading, edges, corners, SiFT features, foreground silhouettes, occlusions, vanishing points, foci of expansion, a motion blur and spatiotemporal intensity fluctuations.

5. The system of claim 1, wherein said altering of said appearance is performed to reinforce a perception of a presence of said user within a virtual reality.

6. The system of claim 1, wherein said altering of said appearance is performed to reinforce a perception of a presence of said virtual item in a reality for said user, said reality selected from the group consisting of an augmented reality and a mixed reality.

7. The system of claim 1, wherein said altering of said appearance corrects the positioning of said virtual item viewed by said user from said user viewpoint.

8. The system of claim 1, wherein said altering of said appearance is consonant to a movement of said user.

9. The system of claim 8, wherein said altering of said appearance is performed to minimize a motion sickness of said user.

10. The system of claim 8, wherein said movement is constrained, resulting in said property being a homography employing a reduced representation.

11. The system of claim 1, wherein said altering of said appearance is performed by changing parameters of said projection mechanism.

12. The system of claim 11, wherein said parameters are programmable and configurable parameters of a graphics rendering pipeline.

13. The system of claim 11, wherein said parameters are selected from the group consisting of vertex operations, fragment operations and pixel-based operations.

14. The system of claim 11, wherein said parameters are selected from the group consisting of model transformations, view transformation, camera transformations and viewport transformations.

15. The system of claim 11, wherein said parameters govern at least one item selected from the group consisting of shading, diffusion and light-scattering effects applied to image fragments of said virtual item.

16. The system of claim 1, wherein said inside-out camera is employed by a second user of said system.

17. The system of claim 16, wherein said inside-out camera is worn by said second user of said system.

18. The system of claim 1, wherein said inside-out camera and said viewing mechanism are operably connected to each other.

19. The system of claim 1, wherein said viewing mechanism comprises a display unit.

20. The system of claim 19, wherein said display unit and said projection mechanism are operably connected to each other.

21. The system of claim 19, wherein said display unit is selected from the group consisting of a heads-up display (HUD) and a head-mounted display (HMD).

22. The system of claim 1, wherein said viewing mechanism is duplicated for both eyes of said user to produce a stereo vision for said user.

23. The system of claim 1, wherein at least one of said inside-out camera and said projection mechanism is duplicated for both eyes of said user for performing said altering of said appearance stereoscopically.

24. The system of claim 1, wherein said viewing mechanism is an item selected from the group consisting of a virtual reality eyewear, an augmented reality eyewear and a mixed reality eyewear.

25. The system of claim 24, wherein said virtual reality eyewear is selected from the group consisting of virtual reality goggles, virtual reality glasses, virtual reality telescope and virtual reality binoculars, and said augmented reality eyewear is selected from the group consisting of augmented reality goggles, augment reality glasses, augmented reality telescope and augmented reality binoculars, and said mixed reality eyewear is selected from the group consisting of mixed reality goggles, mixed reality glasses, mixed reality telescope and mixed reality binoculars.

26. The system of claim 1, further comprising a control device in communication with at least one of said viewing mechanism and said projection mechanism.

27. The system of claim 26, wherein said control device is a wearable device.

28. The system of claim 26, wherein said control device allows for adjustments to said at least one virtual item.

29. The system of claim 26, wherein said control device is used to control a signal delivered to at least one of said viewing mechanism and said inside-out camera.

30. The system of claim 26, wherein said control device comprises an item selected from the group consisting of a touch sensor, a joystick, an acoustic sensor, a gesture sensor, a digital pen, a proximity sensor, a vicinity sensor, an electromagnetic sensor, an inertial sensor, a vibration sensor and a motion sensor.

31. The system of claim 1, where an auxiliary sensor is utilized to assist in said altering of said appearance.

32. The system of claim 31, wherein said auxiliary sensor is selected from the group consisting of an optical sensor, a magnetometer, an optical flow sensor, a displacement sensor, an acoustic sensor, a Radio Frequency (RF) sensor and an inertial sensor.

33. The system of claim 1, wherein said viewing mechanism employs optics.

34. A system comprising:
(a) a viewing mechanism employed by a viewer for viewing from a device standpoint a reality comprising at least one virtual item;
(b) a projection mechanism for altering an appearance of said at least one virtual item from said device viewpoint based on a property of an inside-out camera.

35. The system of claim 34, wherein said inside-out camera is operably connected to said device.

36. The system of claim 34, wherein said reality is selected from the group consisting of a virtual reality, an augmented reality and a mixed reality.

37. The system of claim 34, wherein said property is selected from the group consisting of a pose, a homography, a parallax, an image sharpness, a lens distortion, an image blur, a vignetting, a lens flare, a brightness, an image texture, a binocular disparity, a z-depth, an optical flow, an image noise, a shading, edges, corners, SiFT features, foreground silhouettes, occlusions, vanishing points, foci of expansion, a motion blur and spatiotemporal intensity fluctuations.

38. The system of claim 34, wherein said device is selected from the group consisting of a manipulated tool, a remotely controlled tool, a remotely controlled device and a wearable device.

39. The system of claim 34, wherein said at least one virtual item is layered onto said reality viewed by said viewer employing said viewing mechanism.

40. The system of claim 34, wherein said viewing mechanism is worn by said viewer.

41. The system of claim 40, wherein said viewing mechanism is selected from the group consisting of a virtual reality eyewear, an augmented reality eyewear and a mixed reality eyewear.

42. The system of claim 41, wherein said virtual reality eyewear is selected from the group consisting of virtual reality goggles, virtual reality glasses, virtual reality telescope and virtual reality binoculars, and said augmented reality eyewear is selected from the group consisting of augmented reality goggles, augment reality glasses, augmented reality telescope and augmented reality binoculars, and said mixed reality eyewear is selected from the group consisting of mixed reality goggles, mixed reality glasses, mixed reality telescope and mixed reality binoculars.

43. The system of claim 34, wherein said projection mechanism is operably connected to said viewing mechanism within a head-worn gear.

44. The system of claim 34, wherein said projection mechanism comprises a display unit.

45. The system of claim 44, wherein said display unit is selected from the group consisting of a heads-up display (HUD) and a head-mounted display (HMD).

46. The system of claim 44, wherein said display unit and said viewing mechanism are fully integrated.

47. The system of claim 46, wherein said display unit and said device are related in a manner selected from the group consisting of: affixed to each other, integrated with each other, connected to each other and attached to each other.

48. The system of claim 34, wherein said altering of said appearance is consonant to a movement of said device.

49. The system of claim 48, wherein said movement is constrained, thereby resulting in said property to be a reduced homography.

50. A method comprising the steps of:
(a) layering a virtual item onto an environment viewed from a user viewpoint by a user employing a viewing mechanism, said layering being performed by a projection mechanism;
(b) adjusting an appearance of said virtual item from said user viewpoint by said projection mechanism based on a property of an inside-out camera mounted on said user.

51. A method comprising the steps of:
(a) layering a virtual item onto a scene viewed from a viewpoint of a viewer selected from the group consisting of a sentient user and a machine, said viewer employing a viewing optics to view said scene;
(b) employing a projection mechanism for causing said layering;
(c) adjusting an appearance of said virtual item from said viewpoint based on a property of an inside-out camera.

52. The method of claim 51, wherein said scene is selected from the group consisting of a virtual reality scene, an augmented reality scene and a mixed reality scene.

53. The method of claim 51, wherein said property is selected from the group consisting of a pose, a homography, a parallax, an image sharpness, a lens distortion, an image blur, a vignetting, a lens flare, a brightness, an image texture, a binocular disparity, a z-depth, an optical flow, an image noise, a shading, edges, corners, SiFT features, foreground silhouettes, occlusions, vanishing points, foci of expansion, a motion blur and spatiotemporal intensity fluctuations.

54. The method of claim 51, wherein said sentient user is a human being.

55. The method of claim 51, wherein said inside-out camera is mounted on said viewer.

56. The method of claim 51, wherein said machine is a device selected from the group consisting of a drone, a robot, a manipulated tool, a remotely controlled tool, a wearable device, a remotely controlled automotive equipment and an artificially intelligent agent.

57. The method of claim 56, wherein said altering of said appearance is consonant to a motion of said viewer.

58. The method of claim 57, wherein a constraint on said motion results in said property to be a homography employing a reduced representation.

59. The method of claim 58, wherein said reduced representation is possible due to an element selected from the group consisting of a structural uncertainty of said viewing optics, and a structural redundancy caused by a conditioned motion of said viewer.

60. A system comprising:
(a) an optical sensor that images a plurality of space points in a reality viewed by a viewer; and
(b) a mechanism for generating a virtual item layered onto said reality;
wherein said system tracks a motion of said viewer, and said mechanism modifies said virtual item accordingly.

61. The system of claim 60, wherein said optical sensor is an inside-out camera.

62. The system of claim 60, wherein said optical sensor is embodied in an element selected from the group consisting of a heads-up display(HUD) and a head-mounted display (HMD).

63. The system of claim 60, wherein said optical sensor is affixed to a manipulated gear worn by said viewer.

64. The system of claim 60, wherein said viewer is a human user with a minimized discomfort due to motion sickness, while viewing said reality.
